(19) United States
(12) Patent Application Publication
(10) Pub. No.: US 2025/0187645 A1
(43) Pub. Date: Jun. 12, 2025

(54) INTERMITTENT MOVEMENT DEVICE, WHEEL LOCKING STRUCTURE AND STROLLER

(71) Applicant: Wonderland Switzerland AG, Steinhausen (CH)

(72) Inventor: Jialiang Yuan, Dongguan, Guangdong (CN)

(21) Appl. No.: 18/845,153

(22) PCT Filed: Mar. 10, 2023
(86) PCT No.: PCT/EP2023/056210

§ 371 Date: Sep. 9, 2024

(30) Foreign Application Priority Data
Mar. 10, 2022 (CN) 202210233697.1
May 10, 2022 (CN) 202210508863.4

(51) Int. Cl. B62B 9/08; B62B 9/26

(52) U.S. Cl. CPC B62B 9/087; B62B 9/082; B62B 9/26

(57) ABSTRACT

An intermittent movement device according to the application includes: a housing; a driving member, disposed in the housing, and capable of rotating around a first axis; a plurality of engagement teeth, circumferentially distributed on the driving member based on the first axis; an operating member, capable of performing reciprocating movement between an initial position and an acting position with respect to the driving member around the first axis; wherein when the operating member moves from the acting position to the initial position, the operating member passes over one of the engagement teeth to return from the acting position to the initial position, and the driving member does not rotate with the operating member. The application further discloses a wheel locking structure and a stroller.

### CROSS-REFERENCE TO RELATED APPLICATIONS

This application is a National Stage application of PCT/EP2023/056210, entitled “INTERMITTENT MOVEMENT DEVICE, WHEEL LOCKING STRUCTURE AND STROLLER” and filed on Mar. 10, 2023, which claims the benefit of Chinese Application No. 202210233697.1, filed on Mar. 10, 2022 and Chinese Application No. 202210508863.4, filed on Mar. 10, 2022, each of which are incorporated herein by reference in their entirety.

### TECHNICAL FIELD

The application relates to an intermittent movement device, a wheel locking structure with the intermittent movement device, and a stroller.

### BACKGROUND

According to the prior art, a locking mechanism of wheels of a stroller includes wheels, a wheel axle rotatably connected to the wheels, and a plurality of locking slots distributed annularly on each wheel, and a parking pedal connected to a stroller frame is disposed on one side of each wheel. When the pedal is stepped down, a parking block connected to the pedal is inserted into one of the locking slots, such that the wheels cannot rotate. When it is required to unlock, the user needs to hook the parking pedal up by instep to make the parking block be separated from the locking slot. Such a locking mechanism needs two actions, moving up and moving down, during operation, which are inconvenient to perform with the foot, and prone to damage and stain the shoe, especially the user's exposed instep if he wears a shoe exposing his instep.

For this reason, it is necessary to propose a new wheel locking structure, which allows reliable locking and unlocking of the wheels by stepping the pedal in one direction.

In order to make it convenient for the baby caregiver to shop or carry articles needed for going out, some strollers will be provided with storage crates for placing articles. However, the existing storage crates on the strollers are often inconvenient to use and provide poor user experience due to limitations such as the connection mode or space cooperative with the stroller frame.

### SUMMARY

An intermittent movement device according to the application includes: a housing; a driving member, capable of rotating around a first axis; a plurality of engagement teeth, circumferentially distributed on the driving member based on the first axis; an operating member, capable of performing reciprocating movement between an initial position and an acting position with respect to the housing around the first axis; wherein when the operating member moves from the acting position to the initial position, the operating member passes over one of the engagement teeth to return from the acting position to the initial position, and the driving member does not rotate with the operating member.

In an embodiment, the plurality of engagement teeth are capable of rotating between respective engagement position and avoidance position with respect to the driving member; when the operating member moves from the initial position to the acting position, the operating member pushes one of engagement teeth into the engagement position, and brings the driving member to rotate along a rotating direction via one of the engagement teeth; and when the operating member moves from the acting position to the initial position, the operating member passes over a next one of engagement teeth behind the one of the engagement teeth in the rotating direction to return from the acting position to the initial position, and the driving member does not rotate with the operating member.

In an embodiment, each of the engagement teeth is capable of rotating between the engagement position and the avoidance position with respect to the driving member around a respective second axis, and the second axis is parallel to the first axis; or each of the engagement teeth is capable of linearly moving between the engagement position and the avoidance position along a direction perpendicular to the first axis.

In an embodiment, each of the engagement teeth includes a forward face and a backward face, and the forward face and the backward face form an included angle with each other; the operating member includes a pushing portion to exert a pushing action on one of the engagement teeth; when the operating member moves from the initial position to the acting position, the pushing portion of the operating member pushes against the forward face of one of the engagement teeth, such that one of the engagement teeth is in the engagement position; and when the operating member moves from the acting position to the initial position, the pushing portion passes over the next one of engagement teeth and makes the next one of engagement teeth in its avoidance position by pushing against the backward face of the next one of engagement teeth.

In an embodiment, the intermittent movement device further includes: a plurality of engagement tooth elastic members, respectively arranged between the plurality of engagement teeth and the driving member to bias the engagement teeth to the engagement position; and the engagement teeth protrude farther radially with respect to the first axis in the engagement position than in the avoidance position.

In an embodiment, the engagement tooth elastic members are compression springs, and each of the engagement teeth includes an engagement tooth elastic member accommodation portion to at least partially accommodate one end of each of the engagement tooth elastic members.

In an embodiment, the driving member includes: a plurality of engagement tooth grooves, concavely formed from one side surface of the driving member, and distributed circumferentially based on the first axis, so as to respectively accommodate the plurality of engagement teeth, each of the engagement tooth grooves includes: an engagement limit portion, for resisting a corresponding one of the engagement teeth from further rotating beyond the engagement position with respect to the driving member when the engagement tooth is in its engagement position; an avoidance limit portion, for resisting a corresponding one of the engagement teeth from further rotating beyond the avoidance position with respect to the driving member when the engagement tooth is in its avoidance position; and an engagement tooth elastic member abutting portion, arranged adjacent to the avoidance limit portion for being abutted against by the other end of the engagement tooth elastic member.

In an embodiment, the engagement limit portions, the avoidance limit portions, and the engagement tooth elastic member abutting portions are all axially extending walls of the engagement tooth grooves, and the engagement limit portions are radially opposite to both the avoidance limit portions and the engagement tooth elastic member abutting portions, wherein the engagement limit portions are radial outer side walls of the engagement tooth grooves, the avoidance limit portions and the engagement tooth elastic member abutting portions are respectively radial inner side walls of the engagement tooth grooves.

In an embodiment, a stroke of each reciprocating movement of the operating member is equal to or greater than a spacing between two adjacent engagement teeth.

In an embodiment, the operating member further includes an operating member body, and the operating member body is coaxially arranged with the driving member along the first axis; the plurality of engagement teeth are arranged on a side of the driving member facing the operating member body; and a pushing portion is disposed on a side of the operating member body facing the driving member, and the pushing portion is arranged to protrude axially and push against one of the engagement teeth when the operating member moves from the initial position to the acting position.

In an embodiment, the housing includes a disk-shaped surface opposite to the operating member body, and a circumferentially extending insertion slot is formed in the disk-shaped surface; the operating member further includes an insertion post, and the insertion post extends axially toward an interior of the housing; the insertion post is inserted into the insertion slot, slides along the insertion slot when the operating member performs reciprocating movement with respect to the driving member, and the insertion slot limits a stroke of the movement of the operating member between the acting position and the initial position; and the intermittent movement device further includes an operating elastic member, the operating elastic member is disposed in the insertion slot and abuts between an end wall of the insertion slots and the insertion post, biasing the operating member to the initial position.

A wheel locking structure according to the application includes: the intermittent movement device according to the application; a wheel, rotatably connected to the housing around the first axis, the wheel is provided with a parking hole on a side facing the housing, and the operating member and the wheel are located on opposite sides of the driving member; a pin, disposed in the housing and located between the driving member and the wheel, and capable of moving axially between a parking position and a non-parking position, in the parking position, the pin is inserted into the parking hole to prevent the wheel from rotating, and in the non-parking position, the pin leaves the parking hole to allow the wheel to rotate; wherein the driving member of the intermittent movement device is rotatably connected in the housing and abutting against one end of the pin, the driving member is provided with parking portions protruding toward the wheel and non-parking portions recessed away from the wheel on a side abutting against the pin, and as the driving member rotates, one of the parking portions or one of the non-parking portions abuts against the pin, such that the pin moves to the parking position or the non-parking position.

In an embodiment, the pin is provided with a first indicating portion and a second indicating portion axially arranged and have different visual effects; a circumferential wall of the housing is provided with an indication window, when the pin is in the non-parking position, the first indicating portion is exposed to outside corresponding to a position of the indication window, and when the pin is in the parking position, the second indicating portion is exposed to outside corresponding to the position of the indication window.

In an embodiment, a pin elastic member is disposed between the pin and the housing, and the pin elastic member biases the pin to the non-parking position.

In an embodiment, the parking portions and the non-parking portions are alternately distributed around the first axis.

In an embodiment, the wheel locking structure further includes: the other wheel, arranged in pair with the wheel and rotatably connected to the other housing around the first axis, and the other wheel is provided with the other parking hole on a side facing the other housing; the other pin, arranged in the other housing, capable of moving axially between its parking position and non-parking position, in the parking position of the other pin, the other pin is inserted into the other parking hole to prevent the other wheel from rotating, and in the non-parking position of the other pin, the other pin leaves the other parking hole to allow the other wheel to rotate; the other driving member, rotatably connected in the other housing and connected against one end of the other pin, the other driving member is provided with the other parking portion protruding toward the other wheel and the other non-parking portion recessed away from the other wheel on a side abutting against the other pin, and as the other driving member rotates, the other parking portion or the other non-parking portion abuts against the other pin, such that the other pin moves to the other parking position or the other non-parking position; a cable, having one end connected to a cable second end connecting portion at a periphery of the other driving member, and the other end connected to the driving member through a linkage mechanism, when one of the parking portions of the driving member abuts against the pin to enter its parking position, the driving member brings the other driving member to move by the linkage mechanism and the cable, such that the other driving member rotates to the other parking portion abutting against the other pin to enter it parking position.

In an embodiment, the linkage mechanism includes: a linkage slider, disposed in the housing and capable of sliding with respect to the wheel in a direction perpendicular to the first axis, and the other end of the cable is connected to a cable first end connecting portion of the linkage slider; a linkage seat, disposed in the housing and capable of sliding with respect to the wheel in a direction parallel to the first axis, the linkage seat and the linkage slider are engaged in an inclined plane; and the linkage mechanism is configured such that when one of parking portions abuts against the pin, another one of the parking portions abuts against the linkage seat, such that the linkage seat slides in a direction parallel to the first axis, and the linkage seat brings the linkage slider to slide vertically to the first axis through inclined plane engagement, and the linkage slider brings the other driving member to rotate through the cable.

A stroller according to the application includes: a stroller frame; a stroller seat, erected on the stroller frame; a front wheel and a rear wheel, disposed below the stroller frame; and the wheel locking structure according to the application, wherein the wheel is the front wheel or the rear wheel.

The present application provides a stroller with a storage crate that is convenient to use and has a good user experience.

An aspect of the disclosure provides a stroller comprising:
a stroller frame;
a storage crate (2200), detachably arranged on the stroller frame and including a storage basket and a handlebar, wherein the handlebar is rotatably connected to the storage basket; and
a locking mechanism, wherein the handlebar is able to rotate to a first rotating position to make the locking mechanism in a locked state where the storage crate and the stroller frame are locked with respect to each other, and the handlebar is able to rotate to a second rotating position to make the locking mechanism in an unlocked state where the storage crate and the stroller frame are unlocked with respect to each other.

In such stroller, by the locking mechanism arranged between the stroller frame and the storage crate, locking and unlocking between the storage crate and the stroller frame can be realized only by rotating the handlebar with one hand, which is convenient to operate. For example, a first rotating position can be set as the position where the handlebar is horizontally arranged, and a second rotating position can be set as the position where the handlebar is vertically arranged. When it is necessary to move the storage crate away from the stroller frame, it is only required to rotate the handlebar from the horizontal position to the vertical position with one hand to unlock the storage crate from the stroller frame, so as to lift the storage crate away from the stroller frame. In addition, there is no need to arrange any additional operating member between the stroller frame and the storage crate to realize unlocking and locking between the storage crate and the stroller frame, which is simple in structure and saves costs.

In an embodiment, the locking mechanism includes an actuating member, a first locking portion, and a second locking portion, the actuating member is fixed on the handlebar, the first locking portion is arranged on the storage crate, the second locking portion is arranged on the stroller frame, and the handlebar rotates to bring the actuating member to rotate, such that the actuating member drives the first locking portion and the second locking portion to be locked to each other or unlocked from each other.

In an embodiment, the actuating member is provided with an inclined pushing rib, the first locking portion is an engagement block, the second locking portion is an engagement hole, when the handlebar rotates to the second rotating position, the handlebar is able to bring the actuating member to rotate, so that the pushing rib drives the engagement block to be disengaged from the engagement hole.

In an embodiment, the locking mechanism further includes a pushing block fixedly connected to the engagement block, and the pushing block is able to abut against the pushing rib.

In an embodiment, the locking mechanism further includes a first reset member, and the first reset member always biases the engagement block to move toward a direction to be engaged with the engagement hole.

In an embodiment, the locking mechanism further includes a fixed seat arranged on the stroller frame and a connecting seat arranged on the storage basket, the engagement hole is arranged on the fixed seat, and the engagement block is movably arranged on the connecting seat.

In an embodiment, the fixed seat is provided with a cooperative bulge, and the connecting seat is provided with a cooperative groove matched with the cooperative bulge.

In an embodiment, the locking mechanism further includes a first reset member and a connecting cover, the first reset member is located between the connecting cover and the connecting seat, the connecting seat has an accommodation hole, two ends of the first reset member are respectively abutted against the connecting cover and the engagement block, and the engagement block is movably arranged in the accommodation hole.

In an embodiment, the locking mechanism further includes a positioning member, the positioning member is fixedly connected to the connecting seat, the actuating member is rotatably connected to the positioning member, and the actuating member is able to be fixed at a plurality of positions with respect to the positioning member.

In an embodiment, the positioning member is provided with at least one connecting hole, and the connecting seat is provided with at least one connecting arm being able to be cooperatively fixed with the connecting hole.

In an embodiment, the positioning member is provided with at least one first locating portion, and the actuating member is circumferentially provided with a plurality of second locating portions being able to cooperate with the first locating portion along a circumferential direction; or the actuating member is provided with at least one first locating portion, and the positioning member is provided with a plurality of second locating portions being able to cooperate circumferentially with the first locating portion.

In an embodiment, the positioning member is provided with at least one elastic arm, the elastic arm is provided with at least one positioning convex, and the actuating member is circumferentially provided with a plurality of positioning concaves being able to cooperate with the positioning convex.

In an embodiment, the stroller frame includes a handrail support rod, and the fixed seat is slidably arranged on the handrail support rod.

In an embodiment, the storage basket includes a connecting frame and a covering fabric sleeved on the connecting frame.

In an embodiment, the connecting frame includes a first connecting tube and a second connecting tube, there are two locking mechanisms and the two locking mechanisms are respectively located on left and right sides of the stroller frame, and the connecting pins are arranged on both sides of the connecting seat of each of the locking mechanisms, so as to be inserted and connected to one end of the first connecting tube and one end of the second connecting tube.

Another aspect of the disclosure provides a stroller comprising:
a stroller frame, including a front foot support rod; and
a storage crate, arranged on the front foot support rod.

In such stroller, the storage crate is arranged on the front foot support rod of the stroller frame, which is convenient for the spatial structure design of the stroller. Particularly for the stroller with upper and lower double seats, the storage crate is arranged on the front foot support rod, which can avoid interference of the lower seat of the stroller to the storage crate, thus realizing the effect of coexistence of the storage crate and the lower seat.

In an embodiment, the storage crate includes a connecting frame and a covering fabric sleeved on the connecting frame, and the connecting frame is arranged on the front foot support rod.

In an embodiment, the connecting frame is rotatably connected to the front foot support rod.

In an embodiment, the stroller further comprises a first engagement seat and a second engagement seat, the first engagement seat is arranged on the front foot support rod, and the second engagement seat is arranged on the connecting frame.

In an embodiment, one end of the first engagement seat is rotatably connected to the second engagement seat, and the other end of the first engagement seat is rotatably connected to the front foot support rod.

In an embodiment, the first engagement seat includes a turntable pivoted to the front foot support rod, the turntable is circumferentially provided with a plurality of first cooperative portions, the stroller further comprises a second cooperative portion movably arranged on the front foot support rod, and the second cooperative portion is able to cooperate with any of the first cooperative portions.

In an embodiment, the first cooperative portions are cooperative slots arranged on the turntable, and the second cooperative portion is a cooperative pin movably arranged on the front foot support rod.

In an embodiment, the stroller further comprises a second reset member, and the second reset member always biases the cooperative pin to move toward a direction close to the cooperative slot.

In an embodiment, the first engagement seat and the second engagement seat are detachably connected.

In an embodiment, the stroller frame further includes a first sitting assembly, a second sitting assembly, two handrail support rods, and two rear foot support rods, the first sitting assembly is arranged between the two handrail support rods, and the second sitting assembly is arranged between the two rear foot support rods.

### BRIEF DESCRIPTION OF THE DRAWINGS

FIG. 1 is a perspective view showing a wheel locking structure according to the application, in which the operating member is not pressed down and the wheel is in an unlocked state;

FIG. 2 is a perspective view of the wheel locking structure, in which the operating member has been pressed down and the wheel is in a locked state;

FIG. 3 is a perspective view of the wheel locking structure, in which the operating member is removed to clearly show the internal mechanism including the driving member and the engagement teeth;

FIG. 4 is a partial enlarged view at the block in FIG. 3;

FIG. 5 is a perspective view of the wheel locking structure, in which one wheel is removed to clearly show the housing, the operating member, and the pin, and a part of the housing of the other wheel is removed to clearly show a driving member for the other wheel;

FIGS. 6A and 6B are partial enlarged views at the left and right blocks in FIG. 5, respectively;

FIG. 7 shows an exploded perspective view of part of the stroller frame, the wheel, and the components;

FIG. 8 is a partial enlarged view at the block in FIG. 7;

FIG. 9 shows the stroller frame, the wheel, and the components in a partially exploded perspective view;

FIG. 10 is a partial enlarged view at the block in FIG. 9;

FIGS. 11A to 11C are perspective views of the driving member from different angles, respectively;

FIGS. 12A and 12B are perspective views of the engagement teeth from different angles, respectively;

FIGS. 13A and 13B are perspective views of the operating member from different angles, respectively;

FIGS. 14A and 14B are perspective views of the pin and the pin elastic member assembled together from different angles, respectively;

FIGS. 15 to 17 are sectional views showing an interaction process of the operating member, the driving member, and the engagement teeth;

FIG. 18 is a sectional view showing an abutting relationship between the driving member and the pin;

FIG. 19 is a partial enlarged view at the block in FIG. 18;

FIGS. 20 and 21 are perspective views of the wheel locking structure from different angles, in which a cable is schematically shown in a dotted line;

FIG. 22 is a perspective view of the wheel locking structure, in which the cable is schematically shown in a dotted line, and a part of the other housing is removed to show the other driving member;

FIG. 23 is a perspective view showing the other wheel, the other housing, and the other driving member;

FIGS. 24A and 24B are two perspective views of the other driving member and the other pin from different angles;

FIG. 25 is a perspective view showing the driving member, the pin, the linkage slider, the linkage seat, and a part of the housing;

FIGS. 26A and 26B are schematic views showing the operation of the linkage mechanism, where the pin and the other pin are in their respective non-parking position in FIG. 26A, and the pin and the other pin are in their respective parking position in FIG. 26B;

FIG. 27 shows a sectional view of the wheel having the operating member and a partial sectional view after the wheel having no operating member being removed;

FIG. 28 is a partial enlarged view at the block in FIG. 27;

FIG. 29 is a view showing the linkage slider and the linkage seat, in which the linkage slider is in a proximal position;

FIG. 30 is a partial enlarged view at the block in FIG. 29;

FIG. 31 is a view showing the linkage slider and the linkage seat, in which the linkage slider is in a distal position;

FIG. 32 is a partial enlarged view at the block in FIG. 31;

FIG. 33 is a partial structural schematic view of a stroller according to an embodiment of the disclosure, in which a handlebar is in a first rotating position;

FIG. 34 is a partial structural schematic view of the stroller according to an embodiment of the disclosure, in which the handlebar is in a second rotating position;

FIG. 35 is a structural schematic view of a part of FIG. 34;

FIG. 36 is a structural schematic view of another part of FIG. 34;

FIG. 37 is an exploded view of FIG. 36;

FIG. 38 is an enlarged view of an actuating member in FIG. 37;

FIG. 39 is an enlarged view of a pushing block and an engagement block in FIG. 37;

FIG. 40 is an enlarged view of a positioning member in FIG. 37;

FIG. 41 is a partial sectional view of FIG. 33;

FIG. 42 is an enlarged view at “A” in FIG. 41;

FIG. 43 is a partial sectional view of FIG. 34;

FIG. 44 is an enlarged view at “B” in FIG. 43;

FIG. 45 is a partial exploded view of FIG. 33;

FIG. 46 is an enlarged view at “C” in FIG. 45;

FIG. 47 is a partial exploded view of FIG. 34;

FIG. 48 is an enlarged view at “D” in FIG. 45;

FIG. 49 is an enlarged view of a connecting seat in FIG. 37 from another angle;

FIG. 50 is a structural schematic view of the stroller according to another embodiment of the disclosure, in which the second sitting assembly is a child seat, and the storage crate is in a completely opened state;

FIG. 51 is a structural schematic view of the stroller according to another embodiment of the disclosure, in which the second sitting assembly is a child seat, and the storage crate is in a completely folded state;

FIG. 52 is a structural schematic view of the stroller according to another embodiment of the disclosure, in which the second sitting assembly is a child seat, and the storage crate is detached;

FIG. 53 is a side view of FIG. 50;

FIG. 54 is a side view of FIG. 51;

FIG. 55 is a side view of FIG. 52;

FIG. 56 is a structural schematic view of the stroller according to yet another embodiment of the disclosure, in which the second sitting assembly is a sleep box, and the storage crate is in a completely opened state;

FIG. 57 is a structural schematic view of the stroller according to yet another embodiment of the disclosure, in which the second sitting assembly is a sleep box, and the storage crate is detached;

FIG. 58 is a partial enlarged view of FIG. 52;

FIG. 59 is an enlarged view at “E” in FIG. 58, in which the first engagement seat is in a state where the connecting pin is approximately vertical;

FIG. 60 is a structural schematic view of the structure shown in FIG. 59, in which the first engagement seat is in a state where the connecting pin is inclined downward;

FIG. 61 is a structural schematic view of the first engagement seat in the stroller according to a further embodiment;

FIG. 62 is a structural schematic view of the first engagement seat shown in FIG. 61 in a state where the connecting pin is substantially vertical;

FIG. 63 is a structural schematic view of the first engagement seat shown in FIG. 61 in a state where the connecting pin is inclined downward.

### DETAILED DESCRIPTION

Although the present invention is illustrated and described herein with reference to specific embodiments, the invention should not be limited to the details shown. Exactly, many modifications can be made to these details within the scope of the equivalents of the claims without departing from the invention.

The directional descriptions involved herein, such as “front,” “back,” “up,” and “down,” are only for convenience of understanding. The invention is by no means limited to these directions, but can be adjusted according to the actual situation. Although the application is described with reference to typical embodiments, the terms used are illustrative and exemplary, not restrictive.

It should be noted, when an element is said to be “fixed” to another element, it may be directly on another element or there may be intervening elements between them. When an element is considered to be “connected” to another element, it may be directly connected to another element or there may be intervening elements between them. The terms “vertical,” “horizontal,” “left,” “right,” and similar expressions used herein are only for purpose of illustration and are not mean the only implementation.

Unless otherwise defined, all technical and scientific terms used herein have the same meaning as commonly understood by those skilled in the technical field of the disclosure. The terminology used in the description of the disclosure herein is only for purpose of describing specific embodiments, and is not intended to limit the disclosure. Furthermore, the expression “and/or” used herein includes any and all combinations of one or more related items.

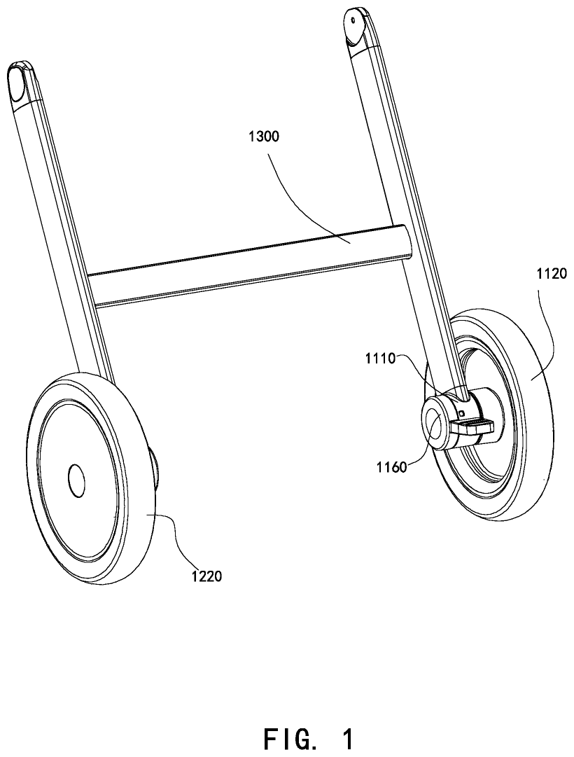

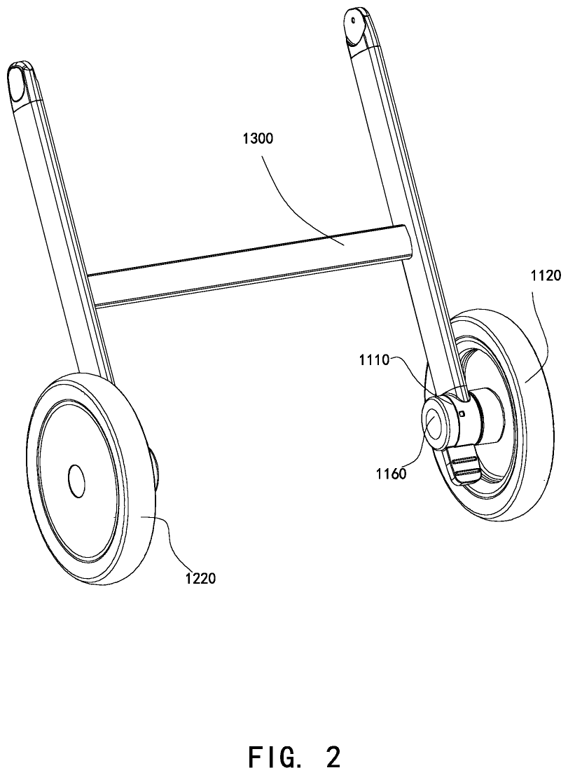

Now a stroller frame 1300 of a stroller according to the application will be generally described with reference to FIGS. 1 to 2. Only the stroller frame 1300 and two wheels installed under the stroller frame 1300 are shown. Other parts of the stroller, such as stroller seat and armrests, are known, so their illustrations and descriptions are omitted. The wheels of the application can be two front wheels in parallel or two rear wheels in parallel of the stroller, preferably the rear wheels, so as to facilitate operation of the user. In order to distinguish, the two wheels are called the wheel 1120 and the other wheel 1220, respectively, which can be respectively corresponding to the left wheel and right wheel, or can be exchanged.

In the wheel locking structure according to the application, an operating member 1160 is disposed at the wheel 1120. A non-pressed state of the operating member 1160 is shown in FIG. 1, and a pressed state of the operating member 1160 is shown in FIG. 2. The user can press (e.g., step on) the operating member 1160, and then release the operating member 1160 to automatically rebound to the non-pressed state, that is, to complete one reciprocating movement of the operating member 1160. Each reciprocating movement of the operating member 1160 will switch the wheel locking structure between a parking state and a non-parking state. In this way, the user can complete a switching between the parking state and the non-parking state without lifting the operating member 1160 upward with instep.

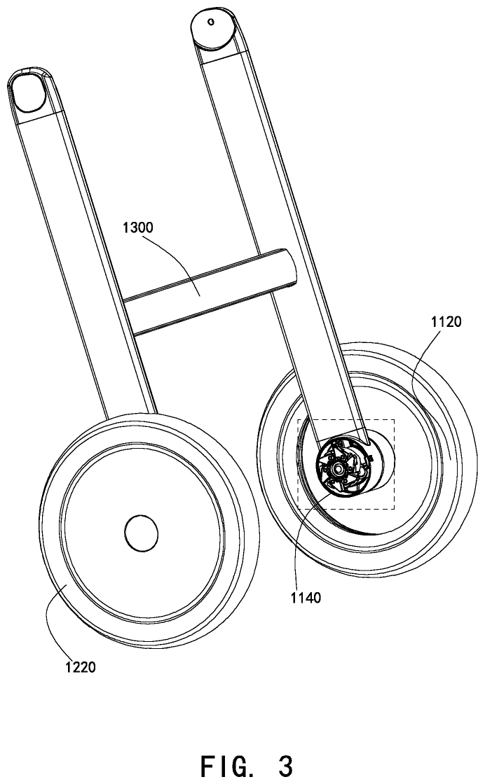

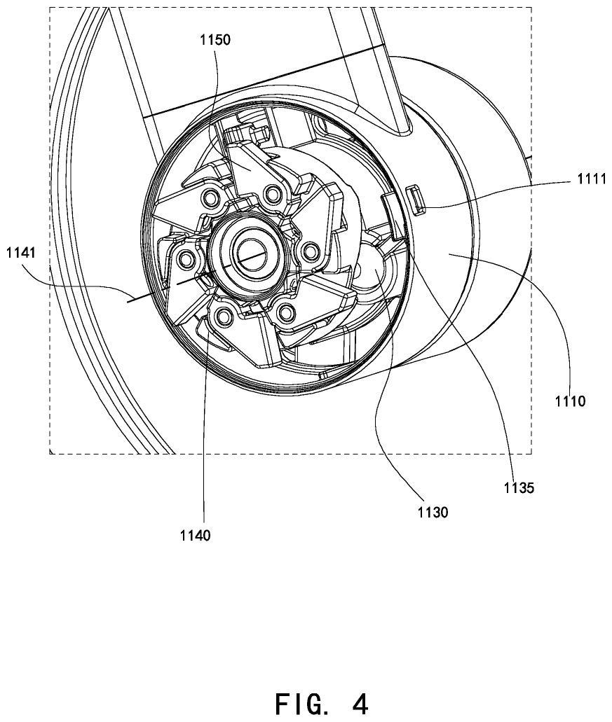

While referring to FIGS. 1 and 2, the wheel locking structure of the application will be further described with reference to FIGS. 3 and 4. The wheel locking structure comprises a wheel 1120, a pin 1130, and an intermittent movement device. Among them, the intermittent movement device comprises a housing 1110, an operating member 1160, a driving member 1140, and engagement teeth 1150. The intermittent movement device is arranged on an inner side of the wheel 1120, and the pin 1130 is arranged between the wheel 1120 and the intermittent movement device.

In this embodiment, the rotational axis of the driving member 1140 and the rotational axis of the wheel 1120 are the same as a first axis 1141, which can simplify the manufacturing process. However, this is not necessary, rather, the rotational axis of the driving member 1140 may deviate from the first axis 1141, such as some other axes parallel to the first axis 1141.

The pin 1130 is provided with a first indicating portion 1134 and a second indicating portion 1135 which are arranged along the axis and have different visual effects (more clearly shown in FIGS. 14A and 14B). The circumferential wall of the housing 1110 is provided with an indication window 1111. When the pin 1130 is in a non-parking position, the first indicating portion 1134 is exposed to the outside corresponding to the position of the indication window 1111, and when the pin 1130 is in a parking position, the second indicating portion 1135 is exposed to the outside corresponding to the position of the indication window 1111. For example, the first indicating portion 1134 may be green and the second indicating portion 1135 may be red.

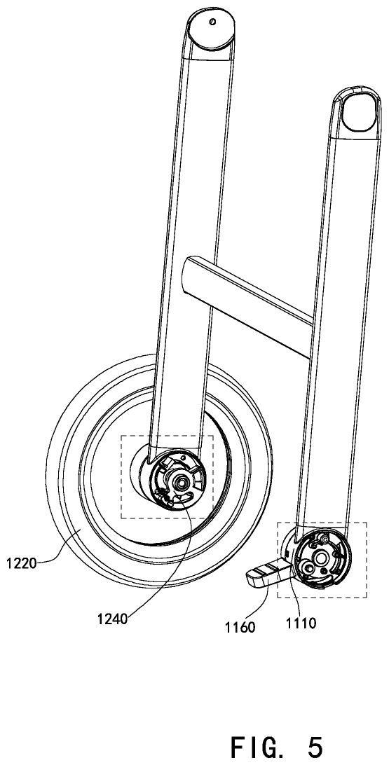

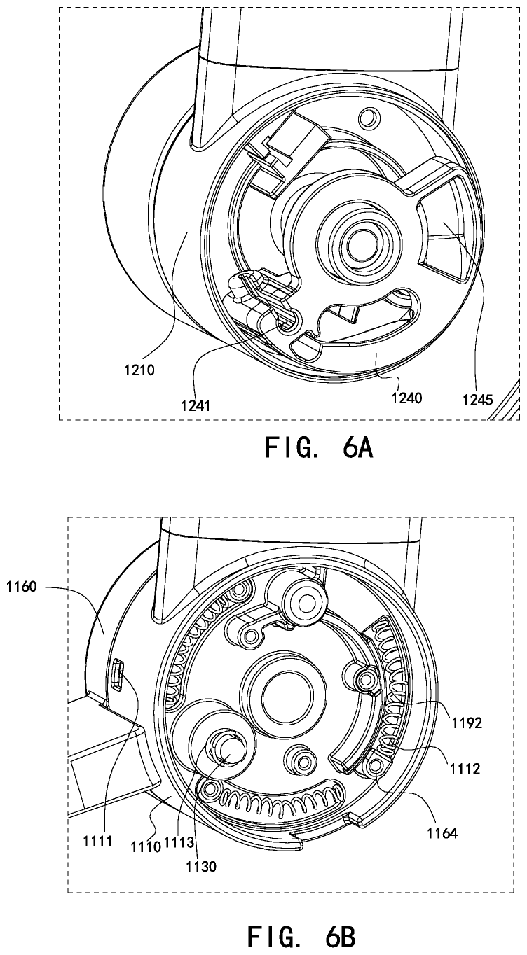

Referring to FIGS. 5 to 6B, the wheel locking structure is shown from another angle. FIG. 6A shows the other housing 1210 and the other driving member 1240, which will be described later together with a linkage mechanism. FIG. 6B shows a side of the housing 1110 facing the wheel 1120, in which the wheel 1120 is removed to clearly show the housing 1110, the operating member 1160, and the pin 1130. It can be seen, the pin 1130 is engaged to the wheel 1120 by passing through a pin hole 1113 in the housing 1110, and the pin 1130 moves axially in the pin hole 1113 without rotating with the operating member 1160 or the driving member 1140 (because the housing 1110 does not rotate).

The housing 1110 is approximately cylindrical with one end open, and includes a disk-shaped surface opposite to an operating member body 1161, and one or more circumferentially extending insertion slots 1112 are formed in the disk-shaped surface. The operating member 1160 includes one or more insertion posts 1164, and each insertion post 1164 extends axially toward the interior of the housing 1110. The insertion post(s) 1164 is inserted into the insertion slot(s) 1112, and slides along the insertion slot(s) 1112 when the operating member 1160 performs a reciprocating movement with respect to the driving member 1140. The insertion slot(s) 1112 limits a stroke of the movement of the operating member 1160 between an acting position and an initial position. The intermittent movement device further comprises one or more operating elastic members 1192. The operating elastic member(s) 1192 is disposed in the corresponding insertion slot(s) 1112 and abuts between an end wall of the insertion slot(s) 1112 and the corresponding insertion post(s) 1164, biasing the operating member 1160 to the initial position (i.e., the non-pressed position shown in FIG. 1).

In this embodiment, the housing 1110 is provided with three insertion slots 1112, and the operating member 1160 is correspondingly provided with three insertion posts 1164. The three insertion posts 1164 are respectively inserted into the three insertion slots 1112, and the three operating elastic members 1192 respectively abut between the three insertion slots 1112 and the three insertion posts 1164. Such arrangement can provide more uniform resilience for the operating member 1160. However, the application is not limited to this, and in other embodiments, more or less insertion slots 1112, insertion posts 1164, and operating elastic members 1192 may be arranged as long as the stroke of the operating member 1160 can be met. Furthermore, the number of the operating elastic member 1192 is not necessarily corresponding to the number of the insertion slots 1112, that is, it is not necessary to provide the operating elastic member 1192 in each insertion slot 1112.

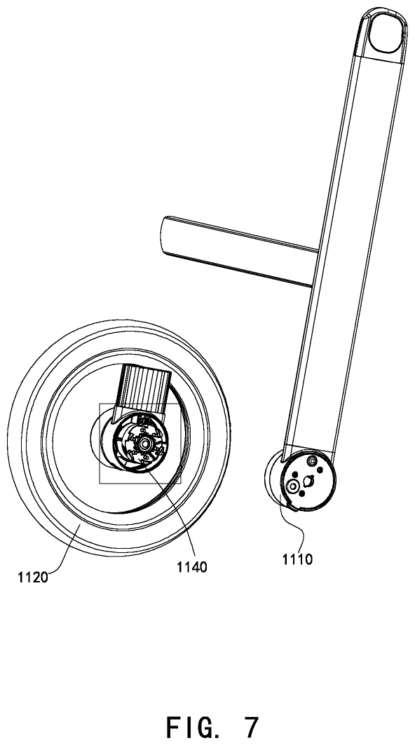

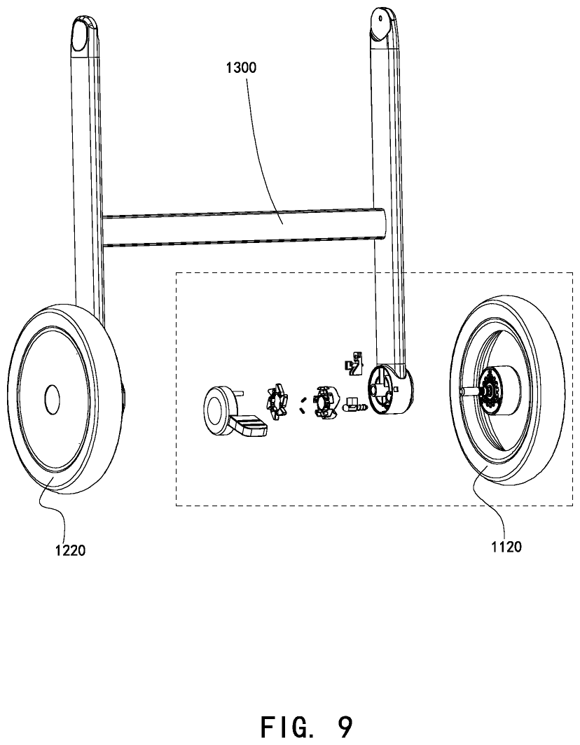

Referring to FIGS. 7 to 10, the assembly relationship of the wheel locking structure according to the application will be described hereinbelow.

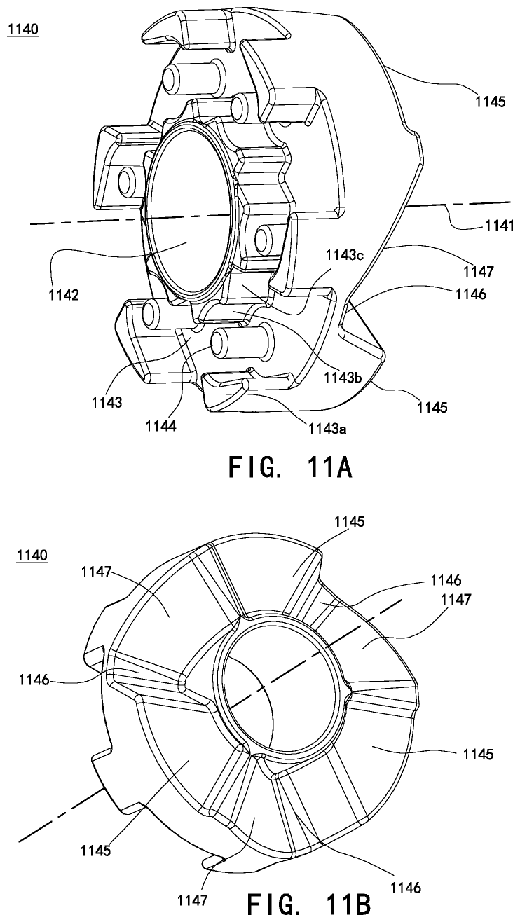

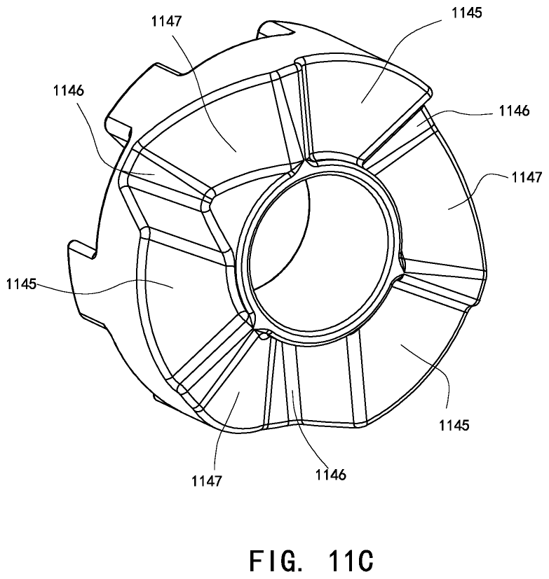

The wheel 1120 is rotatably connected to the housing 1110 around the first axis 1141, and the wheel 1120 is provided with a parking hole 1121 and a wheel axle 1122 on the side facing the housing 1110. More specifically, the wheel axle 1122 is rotatably inserted into a wheel axle hole 1114 of the housing 1110. The operating member 1160 and the wheel 1120 are located at both axial sides of the driving member 1140. The pin 1130 is arranged in the pin hole 1113 of the housing 1110, between the driving member 1140 and the wheel 1120, and can move between the parking position and the non-parking position in the axial direction. In parking position, the pin 1130 is inserted into the parking hole 1121 to prevent the wheel 1120 from rotating, and in the non-parking position, the pin 1130 leaves the parking hole 1121 to allow the wheel 1120 to rotate. The driving member 1140 of the intermittent movement device is rotatably connected in the housing 1110 and always abutting against one end of the pin 1130. The driving member 1140 is provided with a parking portion 1145 protruding toward the wheel 1120, a non-parking portion 1146 recessed away from the wheel 1120, and a driving slope 1147 located between the parking portion 1145 and the non-parking portion 1146 on the side abutting against the pin 1130 (FIGS. 11A and 11B). As the driving member 1140 rotates, the parking portion 1145 or the non-parking portion 1146 abuts against the pin 1130, such that the pin 1130 moves to the parking position or the non-parking position.

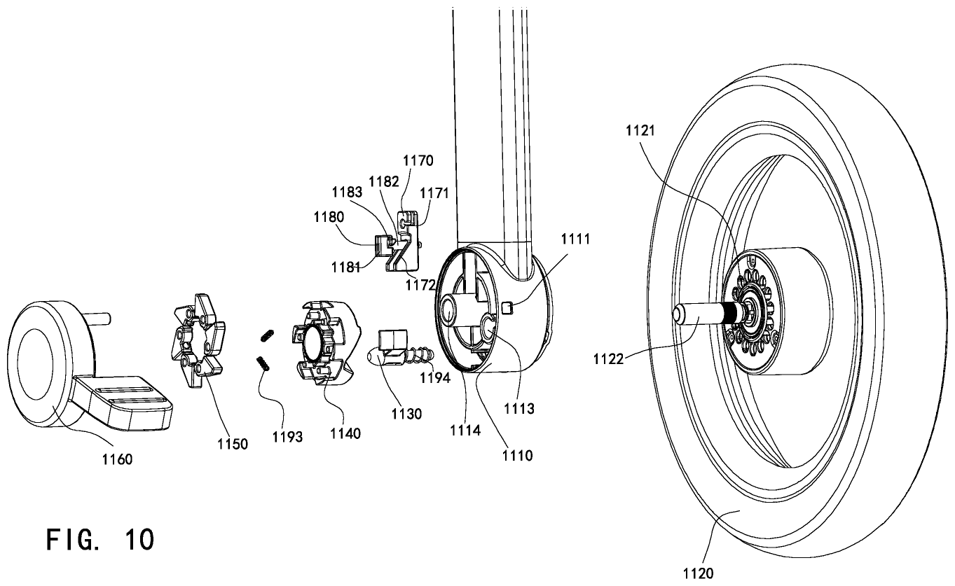

The driving member 1140 is arranged in the housing 1110 and can rotate around the first axis 1141. A plurality of engagement teeth 1150 are uniformly distributed circumferentially based on the first axis 1141 and pivotably connected to the driving member 1140 (see FIGS. 4 and 10). As shown in FIG. 11A, corresponding to the engagement teeth 1150, the side of the driving member 1140 close to the engagement teeth 1150 is provided with a corresponding number of engagement tooth shafts 1144. The engagement teeth 1150 are sleeved on the corresponding engagement tooth shafts 1144, and can respectively rotate between an engagement position (pushed position) and an avoidance position (non-pushed position) with respect to the driving member 1140. The operating member 1160 can perform reciprocating movement between the initial position (non-pressed position) and the acting position (pressed position) around the first axis 1141 with respect to the driving member 1140.

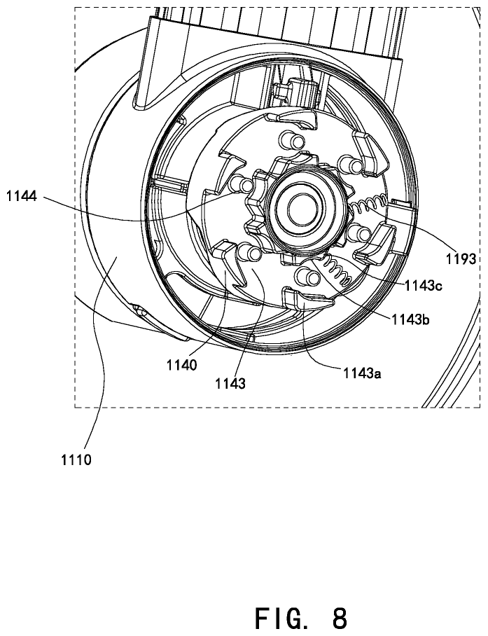

FIGS. 8 to 10 also show position of several engagement tooth elastic members 1193. Although only two engagement tooth elastic member 1193 are shown, it should be understood, each engagement tooth 1150 is provided with a corresponding engagement tooth elastic member 1193.

FIG. 10 also shows a linkage slider 1170 and a linkage seat 1180, and a linkage device including the linkage slider 1170 and the linkage seat 1180 will be described in detail later.

Referring to FIGS. 11A and 11B, the structure of the driving member 1140 will be described in detail hereinbelow. The driving member 1140 is approximately disc-shaped, and includes a driving member shaft hole 1142, engagement tooth grooves 1143, and engagement tooth shafts 1144 on the side facing the operating member 1160, as well as a parking portion 1145 and a non-parking portion 1146 on the side facing the wheel 1120.

The driving member shaft hole 1142 is located at the first axis 1141, and is arranged on the housing 1110 to allow the driving member 1140 to rotate around the first axis 1141.

The engagement tooth grooves 1143 are concavely formed from one side surface of the driving member 1140, and uniformly distributed circumferentially based on the first axis 1141, so as to accommodate the plurality of engagement teeth 1150. Each of the engagement tooth grooves 1143 includes an engagement limit portion 1143a, an avoidance limit portion 1143b, and an engagement tooth elastic member abutting portion 1143c. When the engagement teeth 1150 are in their engagement position, the engagement limit portions 1143a resist the engagement teeth 1150 from further rotating beyond the engagement position with respect to the driving member 1140. When the engagement teeth 1150 are in their avoidance position, the avoidance limit portions 1143b resist the engagement teeth 1150 from further rotating beyond the avoidance position with respect to the driving member 1140. The engagement tooth elastic member abutting portions 1143c are arranged adjacent to the avoidance limit portion 1143b for being abutted against by one end of the engagement tooth elastic member 1193.

In this embodiment, six engagement tooth grooves 1143 are provided. However, in other embodiments, more or less engagement tooth grooves 1143 may be provided corresponding to the number of the engagement teeth 1150.

In this embodiment, the engagement limit portions 1143a, the avoidance limit portions 1143b, and the engagement tooth elastic member abutting portions 1143c are all axially extending walls of the engagement tooth grooves 1143, and the engagement limit portions 1143a are radially opposite to both the avoidance limit portions 1143b and the engagement tooth elastic member abutting portions 1143c. Among them, the engagement limit portions 1143a are radial outer side walls of the engagement tooth grooves 1143, and the avoidance limit portions 1143b and the engagement tooth elastic member abutting portions 1143c are respectively radial inner side walls of the engagement tooth grooves 1143.

More specifically, the engagement limit portions 1143a are close to the outer periphery of the driving member 1140, and the outer surfaces of the engagement limit portions 1143a are flush with the outer peripheral surface of the driving member 1140. A gap between two adjacent engagement limit portions 1143a allows one of the engagement teeth 1150 to protrude to a radial outside of the outer peripheral surface of the driving member 1140. The avoidance limit portions 1143b are close to the driving member shaft hole 1142, and the engagement tooth shafts 1144 are located between the engagement limit portions 1143a and the avoidance limit portions 1143b. In an embodiment, the engagement limit portions 1143a and the avoidance limit portions 1143b are formed in an arc shape opposite to each other, and the engagement tooth shafts 1144 are located at the curvature center of the engagement limit portions 1143a and the avoidance limit portions 1143b.

On the side facing the wheel 1120, the parking portion 1145 of the driving member 1140 protrudes toward the wheel 1120, and the non-parking portion 1146 is recessed away from the wheel 1120. Both the parking portion 1145 and the non-parking portion 1146 are fan-shaped surfaces substantially perpendicular to the first axis 1141. The extension angle of the parking portion 1145 in the circumferential direction is larger than that of the non-parking portion 1146. The non-parking portion 1146 is connected to the parking portion 1145 through a relatively gentle driving slope 1147 at one end, and is connected to another parking portion 1145 through a relatively steep slope at the other end.

The plurality of parking portions 1145 and the plurality of non-parking portions 1146 are uniformly and alternately distributed around the axis of the driving member 1140. In this way, every time the driving member 1140 rotates by one engagement tooth spacing, the position corresponding to the pin 1130 will be switched from one of the parking portions 1145 to one of the non-parking portions 1146, or from one of the non-parking portions 1146 to one of the parking portions 1145.

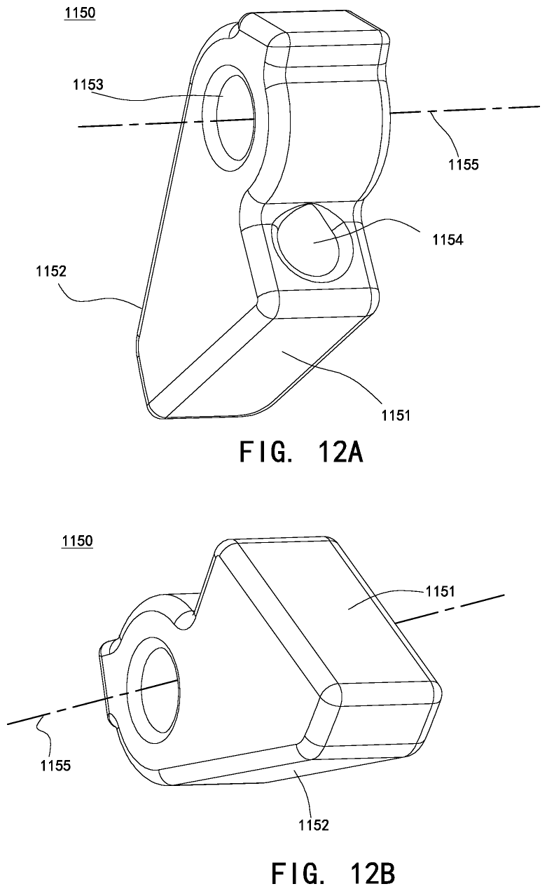

Referring to FIGS. 12A and 12B, the specific structure of the engagement tooth 1150 will be described hereinbelow.

The engagement tooth elastic members 1193 may be compression springs. Each engagement tooth 1150 includes an engagement tooth shaft hole 1153, a forward face 1151, a backward face 1152, and an engagement tooth elastic member accommodation portion 1154. The engagement tooth shaft hole 1153 is located at a second axis 1155 parallel to the first axis 1141, and is sleeved on one of the engagement tooth shafts 1144 of the driving member 1140, so as to allow the engagement teeth 1150 to rotate between the engagement position and the avoidance position around the respective second axes 1155 with respect to the driving member 1140. The forward face 1151 and the backward face 1152, at the free end of the corresponding engagement tooth 1150, both extend axially and form an included angle therebetween, which is an acute angle in this embodiment. The engagement tooth elastic member accommodation portion 1154 is disposed near the engagement tooth shaft hole 1153. The two ends of each engagement tooth elastic member 1193 (FIG. 10) respectively abut against the engagement tooth elastic member accommodation portion 1154 and the engagement tooth elastic member abutting portions 1143c.

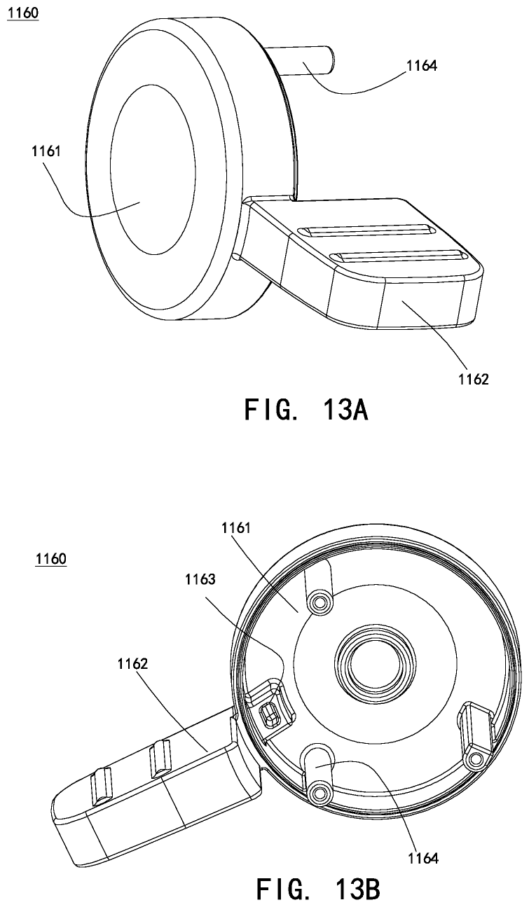

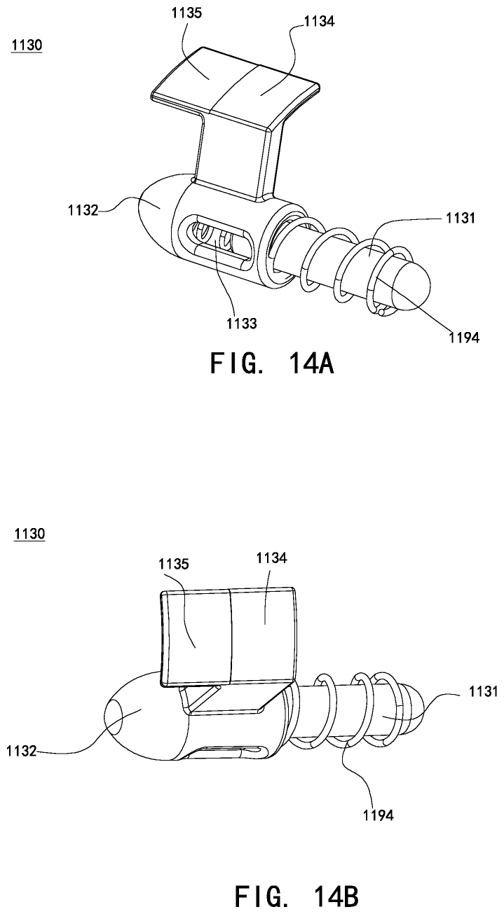

Referring to FIGS. 13A and 13B, the specific structure of the operating member 1160 will be described hereinbelow.

The operating member 1160 includes an operating member body 1161, a pedal 1162, a pushing portion 1163, and insertion posts 1164. The operating member body 1161 is approximately disc-shaped, and is coaxially arranged with the driving member 1140 along the first axis 1141. The engagement teeth 1150 are disposed on the side of the driving member 1140 facing the operating member body 1161. The pushing portion 1163 is disposed on the side of the operating member body 1161 facing the driving member 1140 and protrudes axially. The pushing portion 1163 is arranged to push against one of the engagement teeth 1150 when the operating member 1160 moves from the initial position to the acting position.

Referring to FIGS. 14A and 14B, the specific structure of the pin 1130 will be described hereinbelow.

The pin 1130 includes a pin inserting portion 1131, a pin abutting portion 1132, a pin elastic member accommodating portion 1133, a first indicating portion 1134, and a second indicating portion 1135. The pin 1130 is roughly cylindrical, and the pin inserting portion 1131 and the pin abutting portion 1132 are located at opposite ends of the cylindrical pin 1130, that is, the pin inserting portion 1131 is located at one end facing the wheel 1120, and the pin abutting portion 1132 is located at the other end facing the driving member 1140. The pin elastic member accommodating portion 1133 is arranged as a cylindrical hollow inner space and is open to the pin inserting portion 1131. The first indicating portion 1134 and the second indicating portion 1135 extend outward from a side of the cylindrical. Among them, the first indicating portion 1134 is close to the pin inserting portion 1131, and the second indicating portion 1135 is close to the pin abutting portion 1132. As mentioned above, the first indicating portion 1134 and the second indicating portion 1135 may have different visual effects, such as different colors. A pin elastic member 1194 is sleeved on the pin inserting portion 1131 and at least partially accommodated in the pin elastic member accommodating portion 1133. Both ends of the pin elastic member 1194 respectively abut against the pin elastic member accommodating portion 1133 and the housing 1110, so as to bias the pin 1130 toward the driving member 1140, i.e., toward the non-parking position.

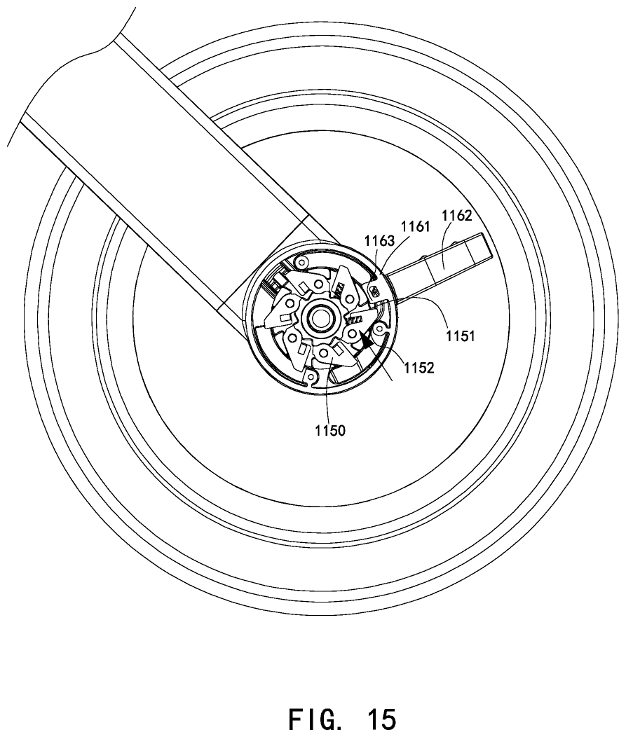

Referring to FIGS. 15 to 17, the operation of the intermittent movement device including the driving member 1140, the operating member 1160, and the engagement teeth 1150 will be described hereinbelow.

In FIG. 15, the operating member 1160 is in the non-pressed position, i.e., the initial position. At this time, the pedal 1162 of the operating member 1160 is roughly at a horizontal position or at a position having an angle with respect to the horizontal plane, such as 30°. The pushing portion 1163 is located above the forward face 1151 of one engagement tooth 1150. For the convenience of understanding, the same engagement tooth 1150 is identified with an arrow in FIGS. 15 to 17. In such state, the pushing portion 1163 may be closely attached to the forward face 1151 or have a certain spacing (idle stroke) from the forward face 1151. At this time, the pin 1130 may be corresponding to the non-parking portion 1146 of the driving member 1140, and may also be corresponding to the parking portion 1145 of the driving member 1140.

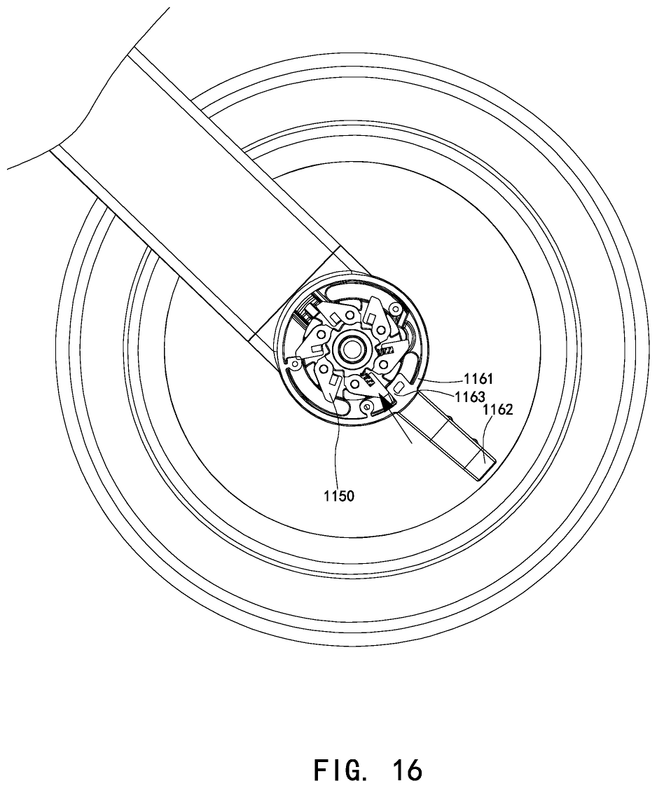

When the user wants to switch the parking/non-parking state, he may press down the operating member 1160, such that the operating member 1160 moves from the initial position to the acting position. When the operating member 1160 moves from the initial position to the acting position, the pushing portion 1163 of the operating member 1160 pushes against the forward face 1151 of one engagement tooth 1150 (i.e., the engagement tooth 1150 indicated by the arrow in FIG. 15), such that the engagement tooth 1150 stays at the engagement position. The engagement tooth 1150 protrudes farther radially with respect to the first axis 1141 when it is in the engagement position than it is in the avoidance position. The pushing portion 1163 pushes the engagement tooth 1150, and in turn, the engagement tooth 1150 brings the driving member 1140 to move. In this way, under the action of the engagement tooth 1150, the driving member 1140 rotates together with the operating member 1160, reaching the state shown in FIG. 16.

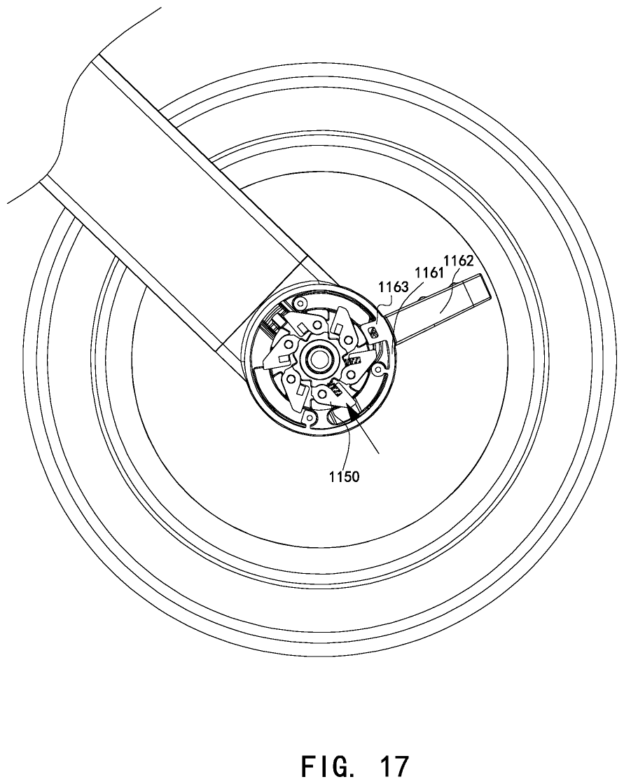

In FIG. 16, the operating member 1160 has reached the pressed position, i.e., the acting position. At this time, the position of the pedal 1162 is in a downward inclined position. The driving member 1140 and each of the engagement teeth 1150 have passed one engagement tooth spacing along with the rotation of the operating member 1160. At this time, the user releases the operating member 1160, and the operating member 1160 will return to the initial position under the action of the operating elastic member 1192 (FIG. 6B), as shown in FIG. 17.

In FIG. 17, when the operating member 1160 moves from the acting position to the initial position, the pushing portion 1163 pushes against the backward face 1152 of the next engagement tooth 1150, such that the engagement tooth 1150 is in its avoidance position. The engagement tooth 1150 in the avoidance position retracts back into the driving member 1140, so the driving member 1140 will not be brought by the operating member 1160 to rotate, that is, during the process of the operating member 1160 moving from the acting position to the initial position, the driving member 1140 does not rotate with the operating member 1160. Therefore, the operating member 1160 returns to the initial position after passing over the next engagement tooth 1150. In this process, the driving member 1140 does not rotate with the operating member 1160.

In this way, during a reciprocating cycle in which the operating member 1160 moves from the initial position to the acting position, and then moves from the acting position to the initial position, the driving member 1140 rotates by one engagement tooth spacing, thus realizing an intermittent movement of the driving member 1140. By such intermittent movement, the stroller is switched from the non-parking state to the parking state, or from the parking state to the non-parking state.

In addition, if there is an idle stroke between the operating member 1160 in the initial position and the engagement teeth 1150, the intermittent movement device can allow an incomplete pressing operation of the user. Specifically, in the case there is provided with an idle stroke, if the operating member 1160 is not completely moved in place during the pressing process, the driving member 1140 and the respective engagement teeth 1150 will not be completely rotated in place, and the pushing portion 1163 of the operating member 1160 can still pass over the next engagement tooth 1150 during the resetting process. In the case there is no idle stroke, if the driving member 1140 and the respective engagement teeth 1150 are not completely rotated in place, the pushing portion 1163 will not be able to pass over the next engagement tooth 1150, resulting in the next reciprocating movement of the operating member 1160 cannot bring the driving member 1140 to move.

In the case there is no idle stroke, a stroke of the reciprocating movement of the operating member 1160 is equal to the spacing between two adjacent engagement teeth 1150. While in the case there is an idle stroke, a stroke of the reciprocating movement of the operating member 1160 is larger than the spacing between two adjacent engagement teeth 1150.

In this embodiment, the engagement teeth 1150 perform rotation movement with respect to the driving member 1140. In other embodiments, the engagement teeth 1150 may also linearly move with respect to the driving member 1140, and each of the engagement teeth 1150 may linearly move between the engagement position and the avoidance position along a direction perpendicular to the first axis 1141, respectively. Specifically, the direction of the linear movement of the engagement teeth 1150 is perpendicular to the first axis 1141, e.g., the radial direction of the driving member 1140.

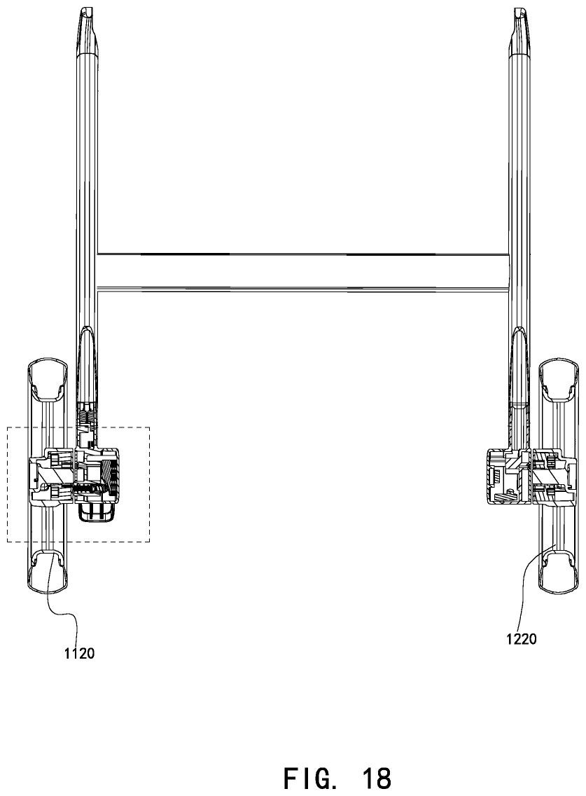

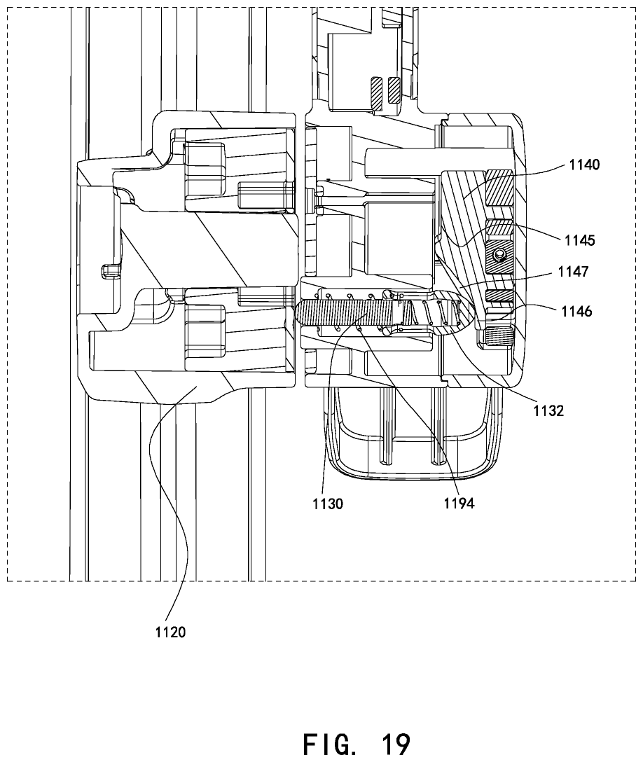

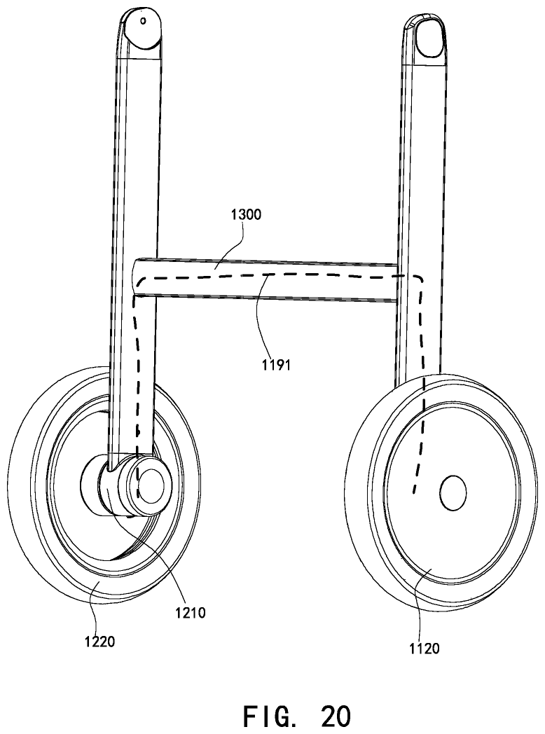

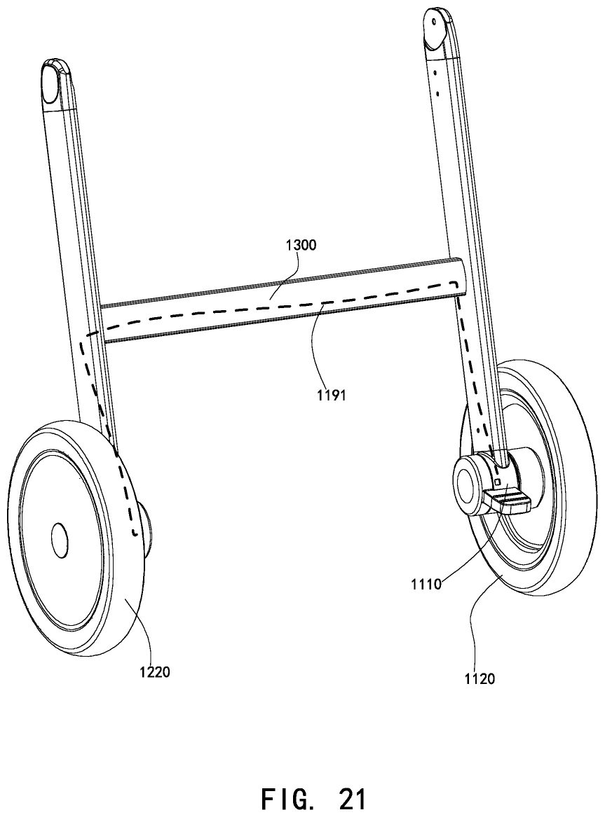

Referring to FIGS. 18 to 19, an interaction between the driving member 1140 and the pin 1130 is shown. In FIGS. 18 and 19, the non-parking portion 1146 of the driving member 1140 is corresponding to the pin 1130, so the pin elastic member 1194 biases the pin 1130 to the non-parking position, i.e., the position away from the wheel 1120. At this time, the pin inserting portion 1131 will not be inserted into the parking hole 1121, and the wheel 1120 can rotate freely. As the driving member 1140 rotates, the driving slope 1146 will push the pin 1130, such that the parking portion 1145 is corresponding to the pin 1130, so the pin 1130 will overcome the bias of the pin elastic member 1194 to reach the parking position, i.e., the position close to the wheel 1120 (not shown). At this time, the pin inserting portion 1131 will be inserted into the parking hole 1121 to prevent the wheel 1120 from rotating.

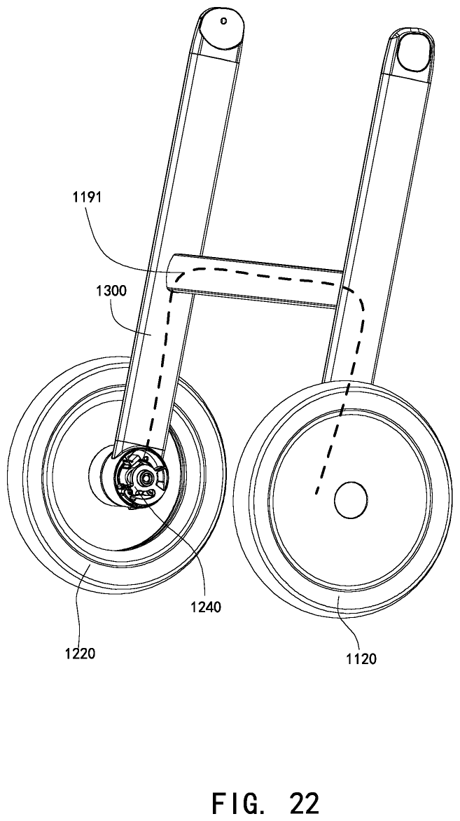

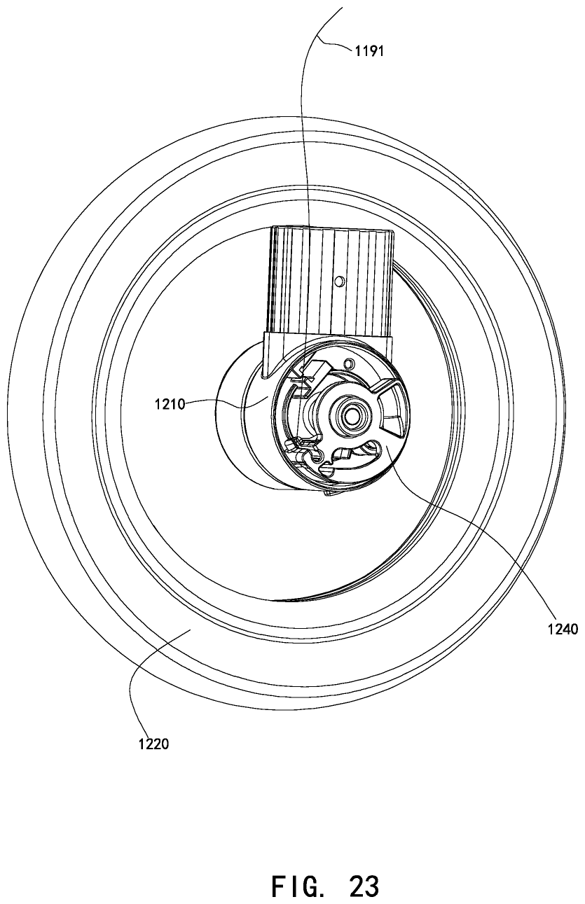

Referring to FIGS. 6A, 10, and 20 to 25, the part of the wheel locking structure at the other wheel 1220 and the linkage mechanism will be described hereinbelow.

In order to provide a braking effect to both the wheel 1120 and the other wheel 1220, the wheel locking structure includes the other wheel 1220, the other housing 1210, the other pin 1230, the other driving member 1240, a cable 1191, and a linkage mechanism.

The other wheel 1220 is arranged in pair with the wheel 1120, and rotatably connected to the other housing 1210 around the first axis 1141. A stroller frame 1300 is erected between the other housing 1210 and the housing 1110, and the other wheel 1220 is provided with the other parking hole (not shown) on the side facing the other housing 1210.

The other pin 1230 is arranged in the other housing 1210. The other pin 1230 has roughly the same structure and arrangement as the pin 1130, and can also move axially between the parking position and the non-parking position. In the parking position of the other pin 1230, the other pin 1230 is inserted into the other parking hole to prevent the other wheel 1220 from rotating, and in the non-parking position of the other pin 1230, the other pin 1230 leaves the other parking hole to allow the other wheel 1220 to rotate.

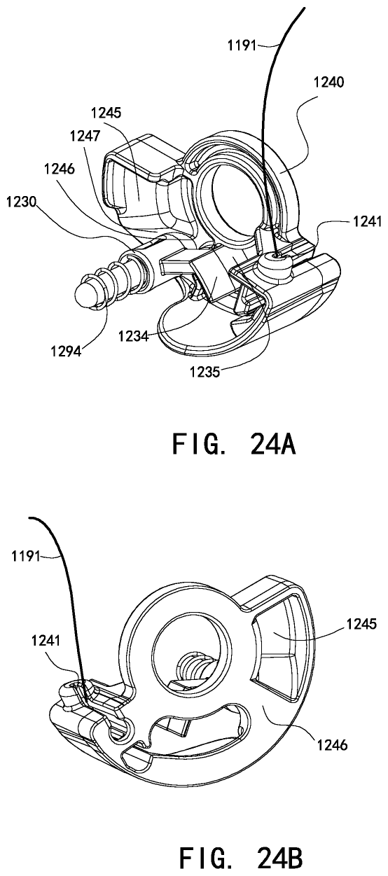

The other driving member 1240 is rotatably connected in the other housing 1210, and abuts against an end of the other pin 1230. The other driving member 1240 is provided with the other parking portion 1245 protruding toward the other wheel 1220 and the other non-parking portion 1246 recessed away from the other wheel 1220 on the side abutting against the other pin 1230. As the other driving member 1240 rotates, the other parking portion 1245 or the other non-parking portion 1246 abuts against the other pin 1230, such that the other pin 1230 moves to its parking position or its non-parking position. As shown in FIG. 24A, the other pin elastic member 1294 is arranged between the other pin 1230 and the other housing 1210 (not shown), and the other pin elastic member 1294 biases the other pin 1230 toward the non-parking position. The other driving slope 1247 is arranged between the other non-parking portion 1246 and the other parking portion 1245. During the rotation of the other driving member 1240, the other driving slope 1247 pushes the other pin 1230 to overcome the bias of the other pin elastic member 1294 and reach the parking position. Unlike the driving member 1140, the other driving member 1240 performs reciprocating movement (well be described in detail below), so it is possible to provide only one parking portion and one non-parking portion, instead of providing a plurality of parking portions and a plurality of non-parking portions like the driving member 1140.

The other pin 1230 is provided with the other first indicating portion 1234 and the other second indicating portion 1235, which are arranged and functioning the same as the first indicating portion 1134 and the second indicating portion 1135, and will not be described redundantly.

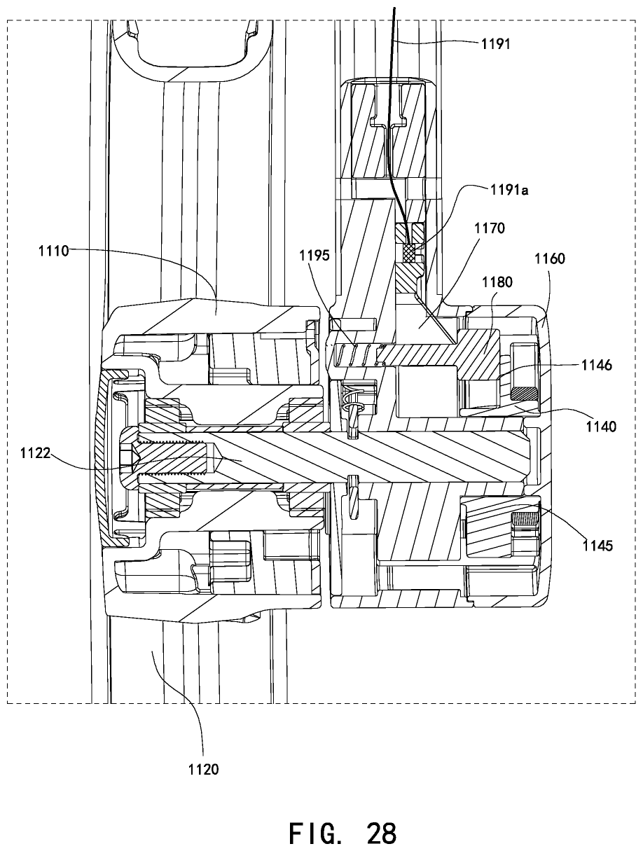

One end of the cable 1191 is connected to a cable first end connecting portion 1171 of a linkage slider 1170 of the linkage mechanism. The other end of the cable 1191 is connected to the periphery of the other driving member 1240, specifically to a cable second end connecting portion 1241 at the periphery of the other driving member 1240. Both ends of the cable 1191 may have hammer heads 1191a (see FIG. 28) or similar structures, so as to be engaged to the cable first end connecting portion 1171 and the cable second end connecting portion 1241. Because the hammer head is a common engagement structure, its specific description is omitted in the application.

The linkage mechanism includes a linkage slider 1170 and a linkage seat 1180. The linkage slider 1170 is disposed in the housing 1110, and can slide with respect to the wheel 1120 in a direction perpendicular to the first axis 1141. The linkage seat 1180 is disposed in the housing 1110, and can slide with respect to the wheel 1120 in a direction parallel to the first axis 1141. The linkage seat 1180 and the linkage slider 1170 are engaged in an inclined plane.

The linkage mechanism is configured such that when one parking portion 1145 abuts against the pin 1130, the other parking portion 1145 abuts against the linkage seat 1180, such that the linkage seat 1180 slides in the direction parallel to the first axis 1141, and the linkage seat 1180 brings the linkage slider 1170 to slide vertically to the axial direction through inclined plane engagement, and the linkage slider 1170 brings the other driving member 1240 to rotate through the cable 1191.

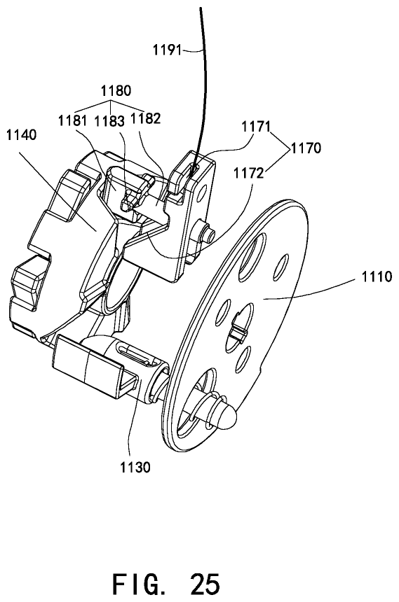

As shown in FIG. 25, the linkage slider 1170 extends roughly in a direction perpendicular to the first axis 1141, and includes a cable first end connecting portion 1171 and slider slopes 1172. The cable first end connecting portion 1171 is at the end of the linkage slider 1170 away from the first axis 1141, which is, for example, formed into a cylindrical groove for the hammer head 1191a of the cable 1191 to be engaged therein. The slider slopes 1172 extend from an approximately middle position of the linkage slider 1170 to an end of the linkage slider 1170 close to the first axis 1141, and extends obliquely toward the driving member 1140. The slider slopes 1172 are provided by two arranged side by side along a direction perpendicular to the first axis 1141, and a gap is formed between the two slider slopes 1172. A cylindrical portion 1182 of the linkage seat 1180 is inserted into the gap to allow the linkage seat 1180 to slide axially with respect to the linkage slider 1170.

The linkage seat 1180 extends roughly in a direction parallel to the first axis 1141, and includes a linkage seat abutment portion 1181, a cylindrical portion 1182, and slope portions 1183. The linkage seat abutment portion 1181 is at an end of the linkage seat 1180 close to the driving member 1140, the cylindrical portion 1182 extends from the linkage seat 1180 to an end of the linkage seat 1180 away from the driving member 1140, and the slope portions 1183 extend laterally from both sides of the linkage seat 1180 and have an inclination corresponding to the slider slopes 1172. The position of the linkage seat 1180 with respect to the driving member 1140 is set such that when one parking portion 1145 of the driving member 1140 abuts against the pin 1130, the other parking portion 1145 of the driving member 1140 abuts against the linkage seat 1180; and when one non-parking portion 1146 of the driving member 1140 abuts against the pin 1130, the other non-parking portion 1146 of the driving member 1140 abuts against the linkage seat 1180.

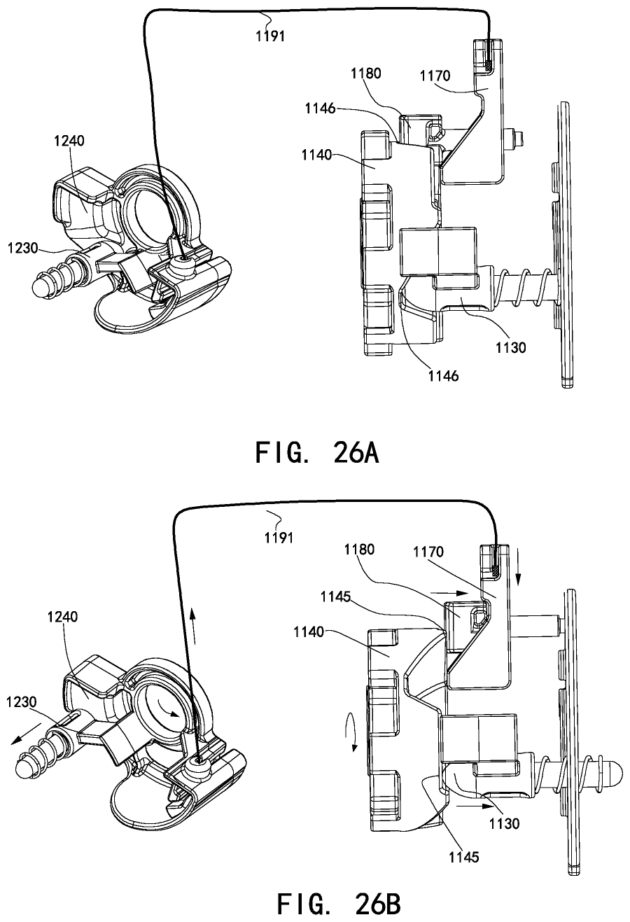

Referring to FIG. 26A, where the pin 1130 and the other pin 1230 are both in their respective non-parking position. At this time, the two non-parking portions 1146 of the driving member 1140 respectively abut against the pin 1130 and the linkage seat 1180. As the driving member 1140 rotates to the state shown in FIG. 26B, one parking portion 1145 of the driving member 1140 abuts against the pin 1130, and the pin 1130 reaches its parking position. Meanwhile, the other parking portion 1145 of the driving member 1140 abuts against the linkage seat 1180, and the linkage seat 1180 moves away from the driving member 1140 (or in other words, toward the wheel 1120). By the abutting relationship between the slope portions 1183 of the linkage seat 1180 and the slider slopes 1172 of the linkage slider 1170, the linkage slider 1170 moves to its proximal position (a position near the bottom). The linkage slider 1170 brings the other driving member 1240 to move by the cable 1191, causing the other driving member 1240 to rotate, such that the other parking portion 1245 abuts against the other pin 1230 to enter its parking position. In this way, a synchronous parking/traveling of the wheel 1120 and the other wheel 1220 is realized.

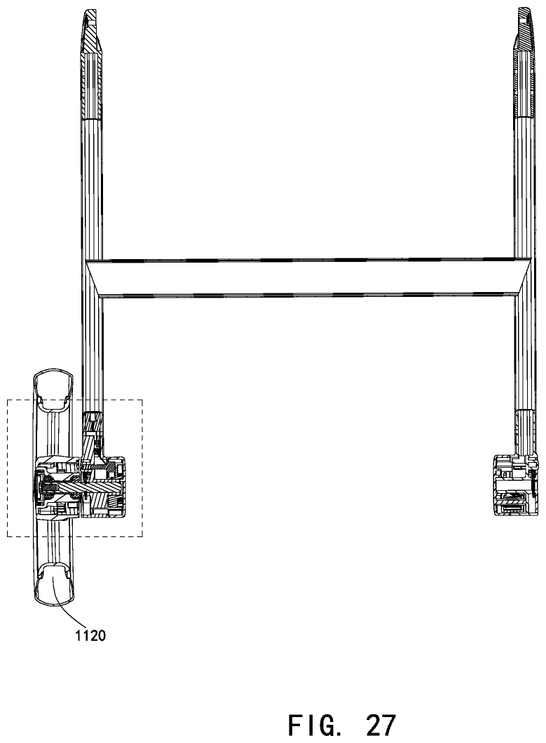

Referring to FIGS. 27 and 28, the arrangement of the linkage slider 1170 and the linkage seat 1180 can be understood through the sectional views, in which the linkage seat elastic member 1195 disposed between the housing 1110 and the linkage seat 1180 is shown.

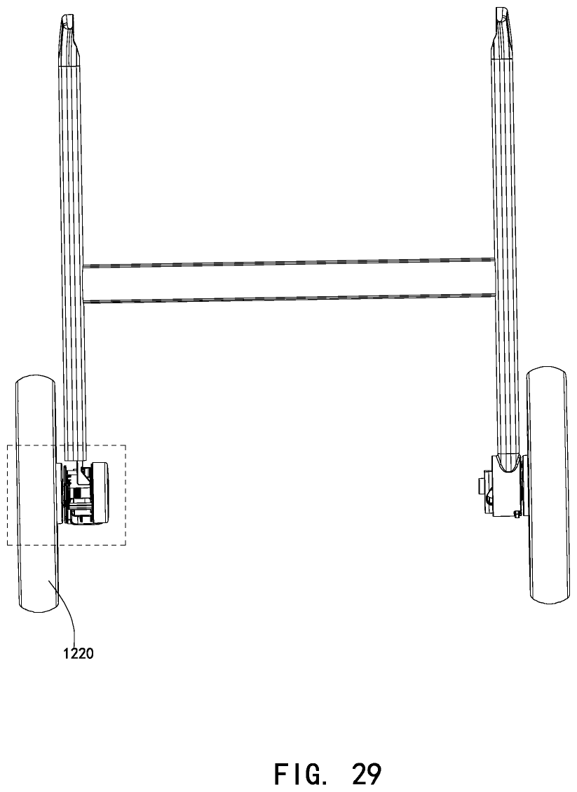

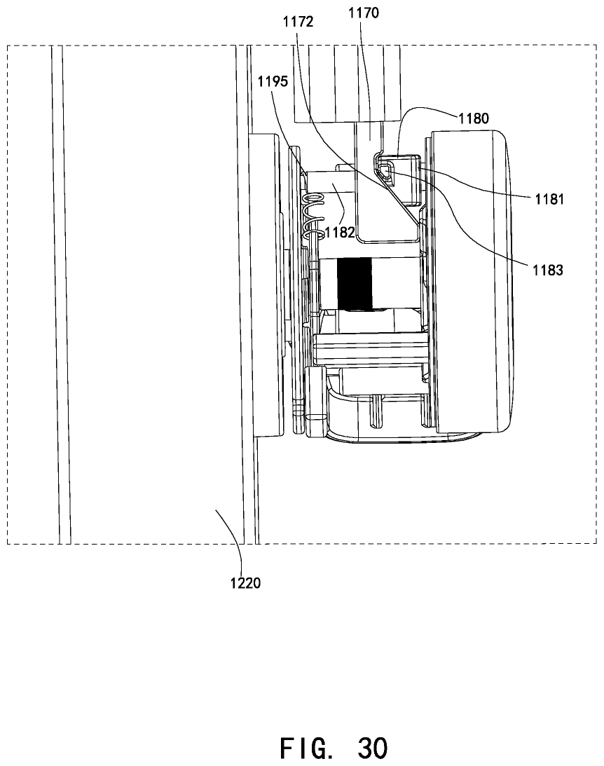

Referring to FIGS. 29 and 30, the parking portion 1145 (not shown) abuts against the linkage seat 1180, such that the linkage seat 1180 slides toward the wheel 1120 (left side in FIG. 30). Under the interaction of the slope portions 1183 and the slider slopes 1172, the linkage slider 1170 slides toward the first axis 1141 (lower side in FIG. 30), thus pulling the cable 1191. Therefore, the cable 1191 will pull the other driving member 1240, such that the other parking portion 1245 of the other driving member 1240 is corresponding to the other pin 1230, and the other pin 1230 reaches the parking position.

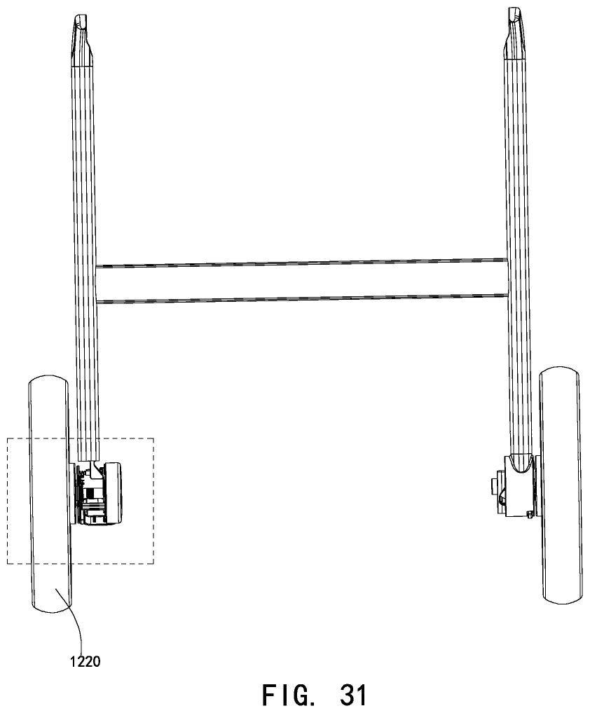

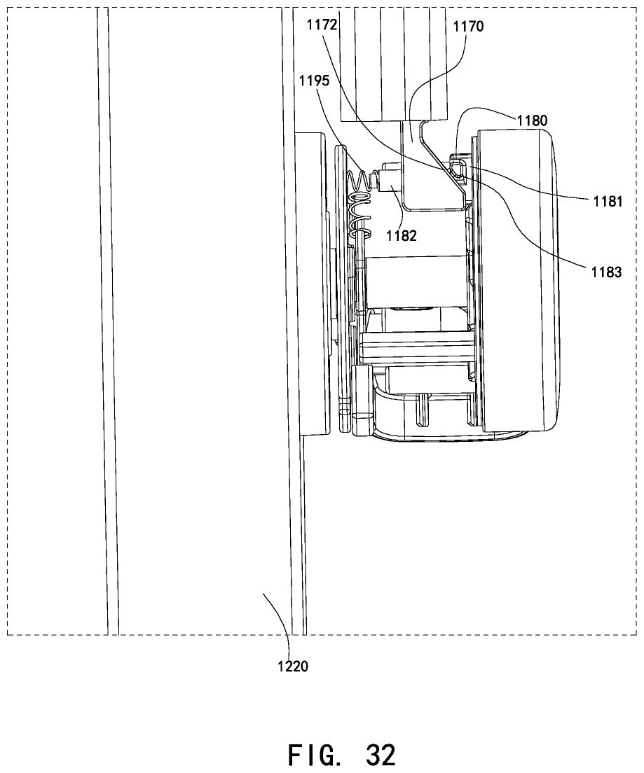

In FIGS. 31 and 32, the non-parking portion 1146 (not shown) abuts against the linkage seat 1180, such that the linkage seat elastic member 1195 arranged between the housing 1110 and the linkage seat 1180 biases the linkage seat 1180 to slide toward the driving member 1140 (right side in FIG. 32). Under the interaction of the slope portions 1183 and the slider slopes 1172, the linkage slider 1170 slides away from the first axis 1141 (upper side in FIG. 32), thus loosening the cable 1191. Therefore, the cable 1191 will loosen the other driving member 1240, such that the other non-parking portion 1246 of the other driving member 1240 is corresponding to the other pin 1230, and the other pin 1230 reaches the non-parking position.

In conclusion, the application provides a wheel locking structure, which allows the user to switch between a parking state and a non-parking state only by pressing down an operating member. The wheel locking structure of the application also allows linkage between two wheels, and the user can switch the parking/non-parking states of both wheels at the same time only by pressing down one operating member.

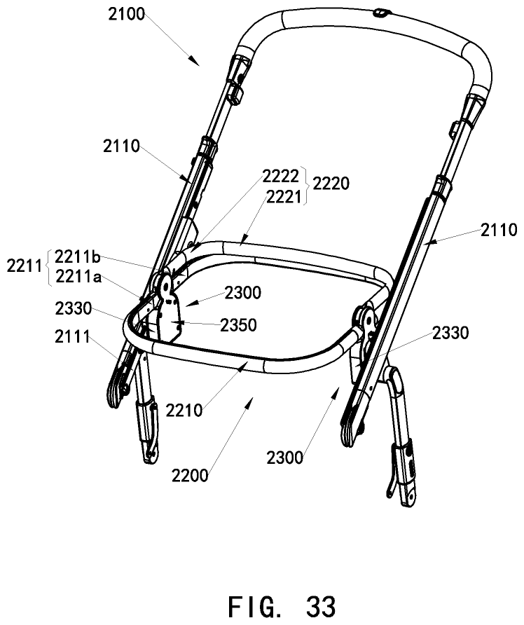

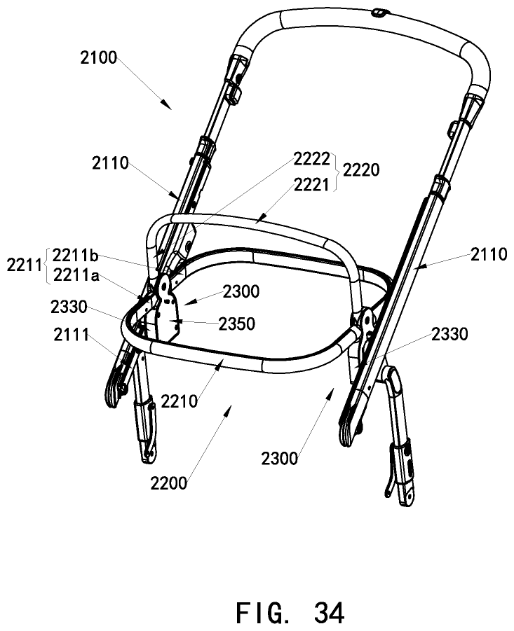

As shown in FIGS. 33 and 34, the stroller according to an embodiment of the disclosure includes a stroller frame 2100, a storage crate 2200, and locking mechanisms 2300. The stroller can realize unlocking and locking between the storage crate 2200 and the stroller frame 2100 only by rotating the handlebar 2220 with one hand, which is convenient to operate without an additional operating member, simple in structure, and cost-saving.

Specifically, the stroller frame 2100 includes two handrail support rods 2110, two front foot support rods (not shown), two rear foot support rods (not shown), and four wheel assemblies (not shown). Lower ends of the two handrail support rods 2110 are respectively connected to top ends of the two front foot support rods, the two rear foot support rods are respectively connected to the two front foot support rods at a certain angle, and the four wheel assemblies are respectively arranged at bottom ends of the two front foot support rods and the two rear foot support rods.

Specifically, as shown in FIGS. 33 and 34, the storage crate 2200 is detachably arranged on the stroller frame 2100. The storage crate 2200 includes a storage basket 2210 and a handlebar 2220. The storage basket 2210 includes a connecting frame 2211 and a covering fabric (not shown) sleeved on the connecting frame 2211. In this way, the covering fabric sleeved outside the connecting frame 2211 forms a storage space for accommodating articles. The connecting frame 2211 is roughly a quadrilateral frame, including a first connecting tube 2211a and a second connecting tube 2211b. Both the first connecting tube 2211a and the second connecting tube 2211b are U-shaped tubes, and are connected by a connecting seat 2330 which will be mentioned later. The handlebar 2220 has roughly a U-shaped bar structure, including a crossbar 2221 and two struts 2222 respectively connected to two ends of the crossbar 2221. The handlebar 2220 is rotatably connected to the storage basket 2210.

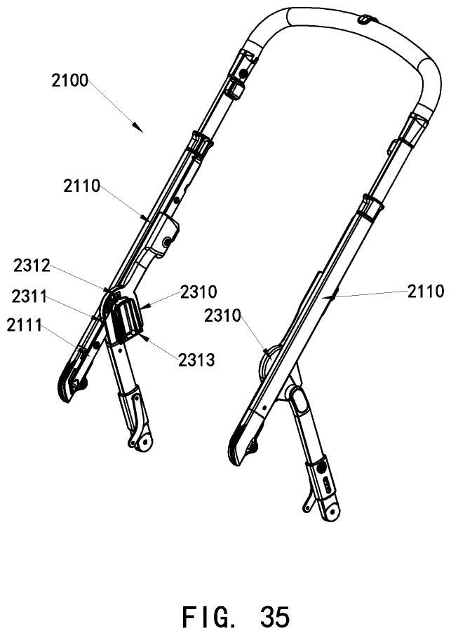

Specifically, as shown in FIGS. 35 to 37, in this embodiment, there are two locking mechanisms 2300, and the two locking mechanisms 2300 are respectively located on left and right sides of the stroller frame 2100. Each of the locking mechanisms 2300 includes a fixed seat 2310, an actuating member 2320, a connecting seat 2330, a connecting pin 2340, a connecting cover 2350, a pushing block 2360, an engagement block 2370, a first reset member 2380, and a positioning member 2390. Taking one of the locking mechanisms 2300 as an example, the structure of the locking mechanisms 2300 will be described in detail hereinbelow:

As shown in FIG. 35, the fixed seat 2310 is slidably arranged on the handrail support rod 2110. Specifically, a chute 2311 can be arranged in the fixed seat 2310, and a slide rail 2111 can be arranged on the handrail support rod 2110. A slidable cooperation between the fixed seat 2310 and the handrail support rod 2110 is achieved through the cooperation between the chute 2311 and the slide rail 2111. The fixed seat 2310 is provided with an engagement hole 2312 and a cooperative bulge 2313. In this embodiment, the engagement hole 2312 is located above the cooperative bulge 2313. Of course, in other embodiments, relative position of the engagement hole 2312 and the cooperative bulge 2313 can also be set according to actual requirements.

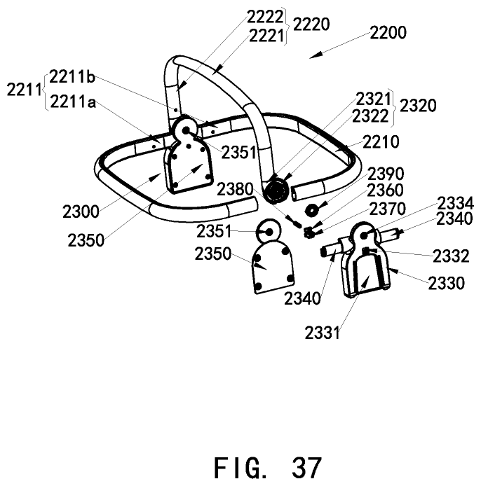

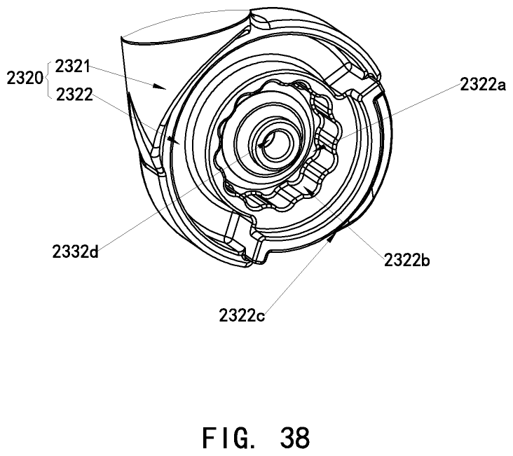

Further, as shown in FIGS. 37 and 38, the actuating member 2320 is arranged between the connecting seat 2330 and the connecting cover 2350. The actuating member 2320 is fixed to an end of one of the struts 2222 of the handlebar 2220 which is away from the crossbar 2221. The actuating member 2320 includes a connecting portion 2321 and a driving body 2322 which is roughly disk shaped. In this embodiment, the connecting portion 2321 and the driving body 2322 are integrally formed. In other embodiments, the connecting portion 2321 and the driving body 2322 may also be formed as independent structures connected to each other. A side of the driving body 2322 is provided with an accommodation slot 2322a having a roughly circular cross section, and a side wall of the accommodation slot 2322a is annularly provided with a plurality of positioning concaves 2322b. An outer peripheral surface of the driving body 2322 is also annularly provided with a pushing rib 2322c, and the pushing rib 2322c is arranged inclined to the axial direction of the driving body 2322.

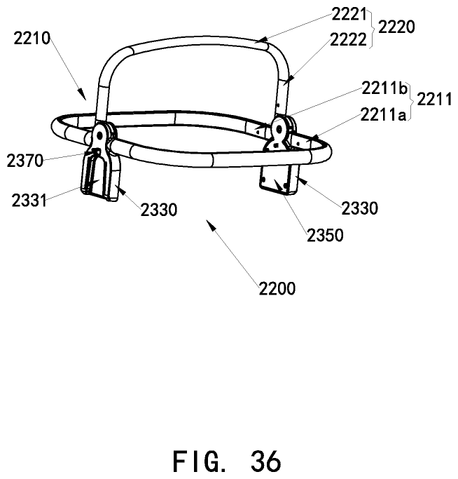

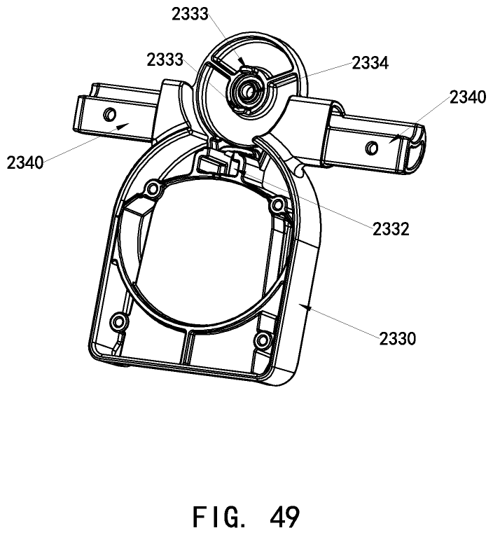

Further, as shown in FIGS. 36, 37, and 49, a side of the connecting seat 2330 facing away from the actuating member 2320 is provided with a cooperative groove 2331, and the cooperative groove 2331 can be cooperative with the cooperative bulge 2313. The connecting seat 2330 is provided with an accommodation hole 2332 for the engagement block 2370 to movably pass through. A side of the connecting seat 2330 facing the actuating member 2320 is provided connecting arms 2333. In this embodiment, the connecting seat 2330 is provided with two connecting arms 2333, and the two connecting arms 2333 are arranged opposite to each other. In other embodiments, the number and arrangement of the connecting arms 2333 may also be adjusted according to actual requirements.

Optionally, as shown in FIGS. 36, 37, and 49, in each locking mechanism 2300, there are two connecting pins 2340, and the two connecting pins 2340 are respectively located on both sides of the connecting seat 2330. In this embodiment, the connecting pins 2340 and the connecting seat 2330 are integrally formed, and in other embodiments, the connecting pins 2340 and the connecting seat 2330 may also be independent structures connected to each other. Moreover, two connecting pins 2340 in one locking mechanism 2300 are respectively inserted and connected to one end of the first connecting tube 2211a and one end of the second connecting tube 2211b, while two connecting pins 2340 in the other locking mechanism 2300 are respectively inserted and connected to the other end of the first connecting tube 2211a and the other end of the second connecting tube 2211b, such that the first connecting tube 2211a and the second connecting tube 2211b are connected to form a roughly square connecting frame 2211. Of course, the connection mode of the first connecting tube 2211a and the second connecting tube 2211b is not limited to this.

Further, as shown in FIGS. 36 and 37, in each locking mechanism 2300, the shape of the connecting cover 2350 matches that of the connecting seat 2330. The connecting cover 2350 and the connecting seat 2330 enclose to form an accommodating space for accommodating the actuating member 2320, the engagement block 2370, the positioning member 2390, and the first reset member 2380, such that the overall appearance structure of the stroller are more concise and beautiful.

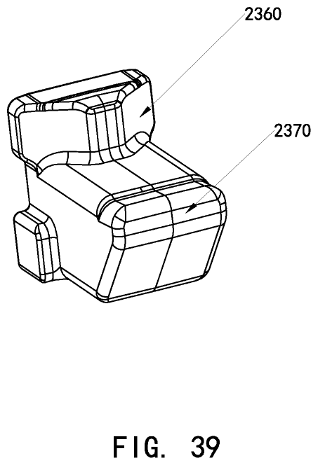

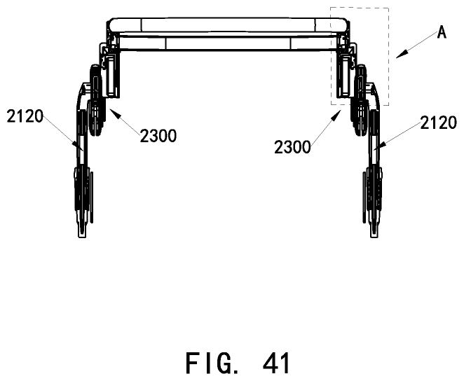

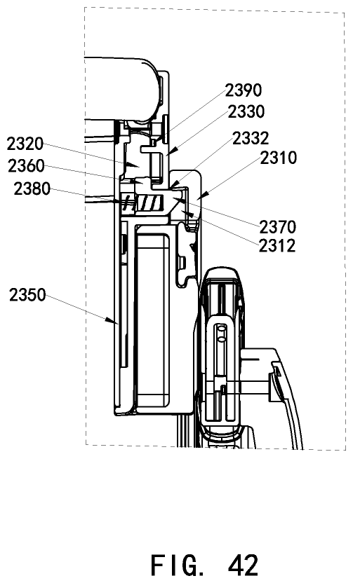

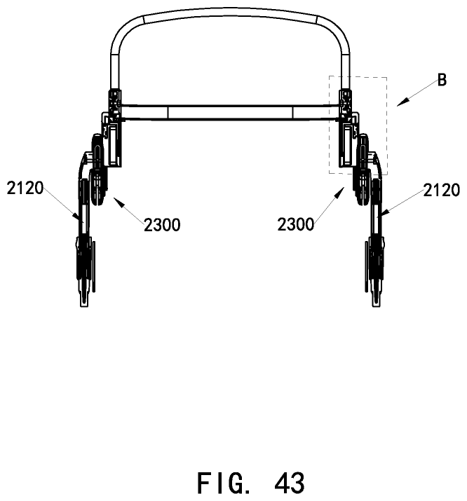

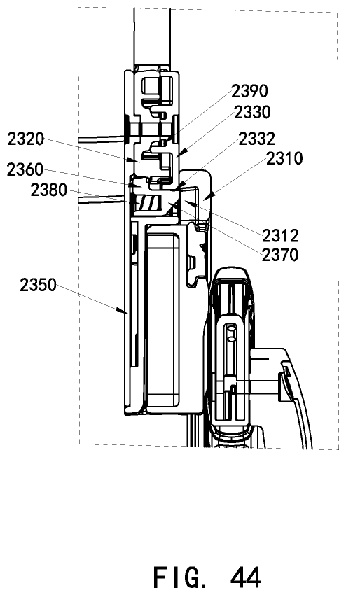

In this embodiment, as shown in FIGS. 37 and 39, in each locking mechanism 2300, the pushing block 2360 and the engagement block 2370 are integrally formed. Of course, in other embodiments, the pushing block 2360 and the engagement block 2370 may also be two independent structures connected to each other. As shown in FIGS. 41 to 44, two ends of the first reset member 2380 respectively abut against the connecting cover 2350 and the engagement block 2370, and the engagement block 2370 is movably arranged in the accommodation hole 2332 along the axial direction of the driving body 2322. The engagement block 2370 can move toward a direction away from the connecting cover 2350, so as to be engaged in the engagement hole 2312, thus realizing locking of the storage crate 2200 and the stroller frame 2100, or vice versa, the engagement block 2370 can move toward a direction close to the connecting cover 2350, so as to be disengaged from the engagement hole 2312, thus realizing unlocking of the storage crate 2200 and the stroller frame 2100. The first reset member 2380 always biases the engagement block 2370 to move toward a direction to be engaged with the engagement hole 2312. In this embodiment, the first reset member 2380 is a spring. Of course, in other embodiments, the first reset member 2380 can also be some other elastic structure. The pushing block 2360 can abut against the pushing rib 2322c.

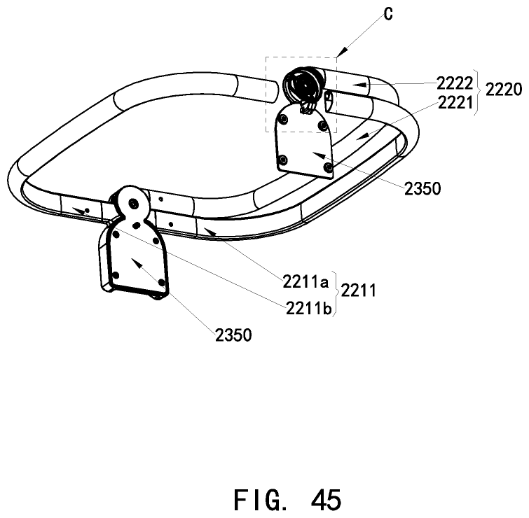

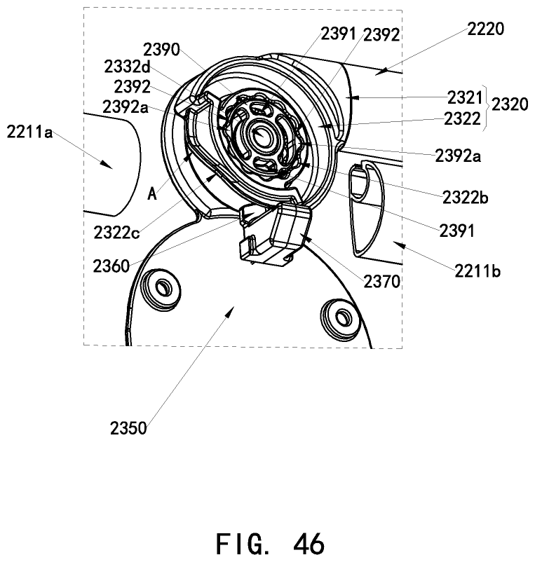

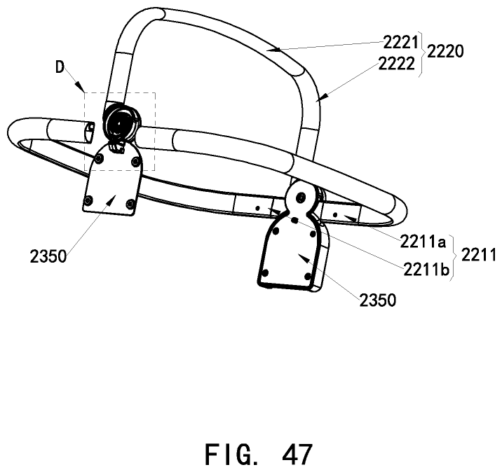

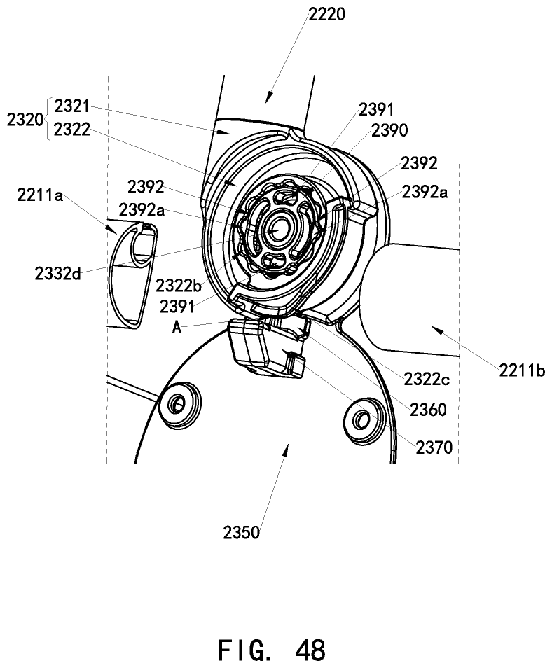

In this embodiment, as shown in FIGS. 45 to 48, the pushing rib 2322c can abut against a side of the pushing block 2360 facing away from the connecting cover 2350. Of course, in other embodiments, the pushing rib 2322c can also be arranged to be able to abut against other position of the pushing block 2360. Since the pushing rib 2322c is arranged to be inclined to the axial direction of the driving body 2322, when rotating of the handlebar 2220 brings the actuating member 2320 to rotate, such that the pushing rib 2322c on the actuating member 2320 abuts against the pushing block 2360 at different position, and the pushing block 2360 moves along the axial direction of the driving body 2322, i.e., the engagement block 2370 moves along the axial direction of the driving body 2322. As shown in FIGS. 47 and 48, when the handlebar 2220 is rotated to the second rotating position (e.g., the handlebar 2220 can be placed vertically), the pushing rib 2322c abuts against the pushing block 2360 at a position A closest to the connecting cover 2350. At this time, the pushing block 2360 is at a position closest to the connecting cover 2350, i.e., at a position farthest from the connecting seat 2330 and the fixed seat 2310, and the first reset member 2380 is compressed. At this time, the engagement block 2370 is disengaged from the engagement hole 2312, and the storage crate 2200 and the stroller frame 2100 are unlocked. As shown in FIGS. 45 and 46, when the handlebar 2220 is rotated to the first rotating position (e.g., the handlebar 2220 can be placed horizontally), the pushing rib 2322c does not abut against the pushing block 2360, and at this time, the engagement block 2370, under an elastic restoring force of the first reset member 2380, moves toward a direction away from the connecting cover 2350, i.e., close to the connecting seat 2330 and the fixed seat 2310, such that the engagement block 2370 can be inserted into the engagement hole 2312 by passing through the accommodation hole 2332, thus realizing locking of the storage crate 2200 and the stroller frame 2100.

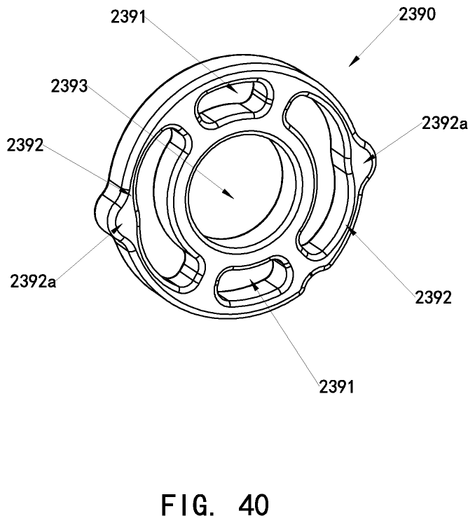

Further, as shown in FIGS. 40, 46, and 48, the positioning member 2390 is disposed in the accommodation slot 2322a. The positioning member 2390 has a roughly hollow disc-shaped structure. The positioning member 2390 is provided with connecting holes 2391 which are cooperative with the connecting arms 2333, so as to realize connection between the connecting seat 2330 and the positioning member 2390. The periphery of the positioning member 2390 is provided with two elastic arms 2392 arranged to be opposite to each other. Each one of the two elastic arms 2392 is provided with at least one positioning convex 2392a which is matched with any one of the positioning concaves 2322b. In this way, the positioning member 2390 and the connecting seat 2330 are relatively fixed. When the handlebar 2220 rotates to bring the actuating member 2320 to rotate with respect to the positioning member 2390 and the connecting seat 2330, the elastic arms 2392 on the positioning member 2390 will be elastically deformed, so that the positioning convexes 2392a on the elastic arms 2392 will cooperate with different positioning concaves 2322b according to a rotation angle of the actuating member 2320, thus realizing locking the handlebar 2220 with respect to the storage crate 2200.

Further, the locking mechanism 2300 also includes a pivot shaft (not shown), the driving body 2322 is provided with a first pivot hole 2322d, the connecting seat 2330 is provided with a second pivot hole 2334, the connecting cover 2350 is provided with a third pivot hole 2351, and the positioning member 2390 is provided with a fourth pivot hole 2393. The pivot shaft passes through the second pivot hole 2334, the fourth pivot hole 2393, the first pivot hole 2322d, and the third pivot hole 2351, thus realizing rotation of the driving body 2322 with respect to the connecting seat 2330, the positioning member 2390, and the connecting cover 2350.

It could be understood, the specific structure of another locking mechanism 2300 is similar to that of this locking mechanism 2300, and will not be redundantly described here.

The use process of the above stroller will be described as follows:

When it is required to unlock and move the storage crate 2200 from the stroller frame 2100, the handlebar 2220 is rotated from the horizontal position to the vertical position, and the actuating members 2320 are brought by the handlebar 2220 to rotate, such that the pushing ribs 2322c abut against the pushing blocks 2360 at the position A. The pushing blocks 2360 brings the engagement blocks 2370 to move towards a direction close to the connecting covers 2350, i.e., away from the connecting seats 2330 and the fixed seat 2310, the first reset members 2380 are compressed, the engagement blocks 2370 are disengaged from the engagement holes 2312, the storage crate 2200 is pulled upward, and the cooperative bulges 2313 are separated from the cooperative groove 2331. At this time, the storage crate 2200 can be unlocked and removed from the stroller frame 2100, as shown in FIGS. 43, 44, 47, and 48.

When it is required to fix the storage crate 2200 on the stroller frame 2100, the storage crate 2200 is placed on the stroller frame 2100, such that the cooperative grooves 2331 of the locking mechanisms 2300 on both sides of the storage crate 2200 (see FIG. 37) are cooperative with the cooperative bulges 2313 of the handrail support rods 2110 slidably arranged on both sides of the stroller frame 2100 (see FIG. 35). The handlebar 2220 is rotated from the vertical position to the horizontal position, and the actuating members 2320 are brought by the handlebar 2220 to rotate, such that the pushing ribs 2322c do not abut against the pushing blocks 2360, the engagement blocks 2370 move together with the pushing blocks 2360 toward the direction away from the connecting covers 2350, i.e., close to the connecting seats 2330 and the fixed seats 2310 under the action of the first reset members 2380, and the engagement blocks 2370 are engaged in the engagement holes 2312, while the storage crate 2200 is locked on the stroller frame 2100.

Such stroller has at least the following technical effects:

In the stroller, the locking mechanisms 2300 are arranged between the stroller frame 2100 and the storage crate 2200, and locking and unlocking between the storage crate 2200 and the stroller frame 2100 can be realized only by rotating the handlebar 2220, which is convenient to operate. For example, the first rotating position can be set as the position where the handlebar 2220 is horizontally arranged, and the second rotating position can be set as the position where the handlebar 2220 is vertically arranged. Then, when it is required to remove the storage crate 2200 from the stroller frame 2100, it is only necessary to rotate the handlebar 2220 from the horizontal position to the vertical position with one hand, so as to unlock the storage crate 2200 from the stroller frame 2100, thus lifting the storage crate 2200 away from the stroller frame 2100. In addition, no any additional operating member is necessary to be arranged between the stroller frame 2100 and the storage crate 2200 to realize unlocking and locking between the storage crate 2200 and the stroller frame 2100, so the structure is simple and the cost is saved.

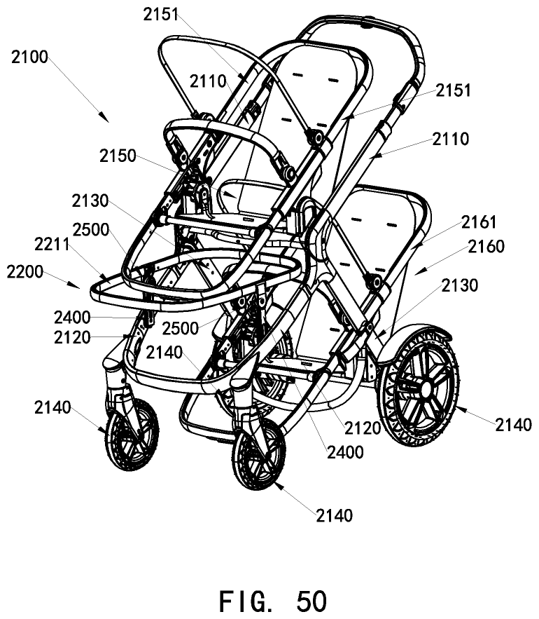

As shown in FIGS. 50-52, 62, and 63, another embodiment of the disclosure provides a stroller including a stroller frame 2100, a storage crate 2200, first engagement seats 2400, second engagement seats 2500, cooperative pins 2600 and second reset members 2700. The stroller can be designed flexibly in spatial structure, which is especially convenient for the arrangement of upper and lower double seats, and can avoid the interference of the lower seat on the storage crate 2200, realizing an effect of coexistence of the storage crate 2200 and the lower seat. The structure of the stroller will be described in detail below by taking a stroller with the upper and lower double seats. It should be understood, the stroller frame 2100 in this embodiment is not limited to the stroller frame 2100 of the stroller with the upper and lower double seats, but also suitable for a stroller with single seat and strollers of other types.

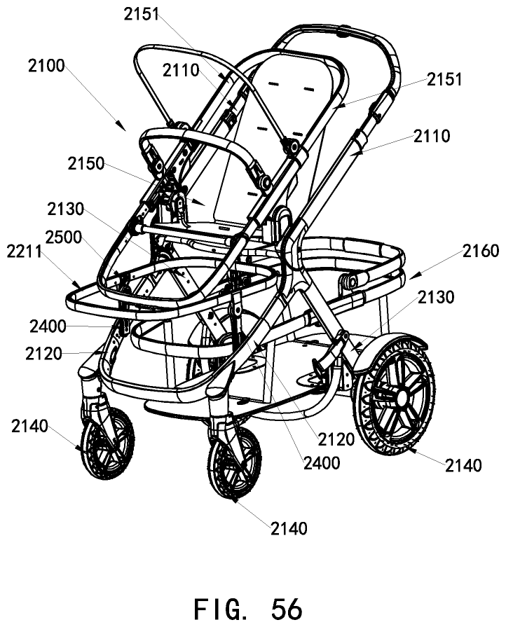

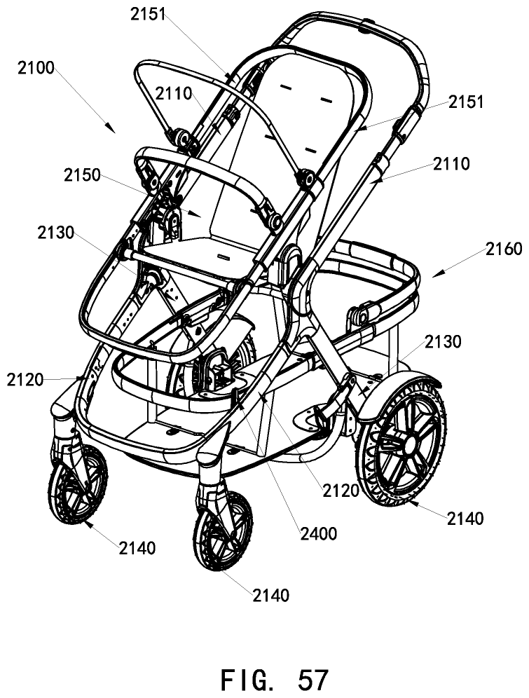

Specifically, as shown in FIGS. 50 to 52, the stroller frame 2100 includes two relatively arranged handrail support rods 2110, two relatively arranged front foot support rods 2120, two relatively arranged rear foot support rods 2130, four wheel assemblies 2140, and a first sitting assembly 2150 and a second sitting assembly 2160. The bottom ends of the two handrail support rods 2110 are respectively connected to the top ends of the two front foot support rods 2120, the two rear foot support rods 2130 are respectively connected to the two front foot support rods 2120 at an angle, and the four wheel assemblies 2140 are respectively disposed at the bottom ends of the two front foot support rods 2120 and the two rear foot support rods 2130. In this way, each of the first sitting assembly 2150 and the second sitting assembly 2160 can accommodate one child respectively, thus achieving the purpose of carrying two children in the same stroller at the same time, which is very convenient for the caregiver to travel. In this embodiment, both the first sitting assembly 2150 and the second sitting assembly 2160 are child seats. The first sitting assembly 2150 includes two first backrest support rods 2151, and the two first backrest support rods 2151 are respectively connected to the two handrail support rods 2110. The second sitting assembly 2160 includes two second backrest support rods 2161, and the two second backrest support rods 2161 are respectively connected to the two rear foot support rods 2130. Of course, in other embodiments, the first sitting assembly 2150 or the second sitting assembly 2160 can also be replaced with car seats or carrycots and the like as required, as shown in FIGS. 56 and 57.

Specifically, as shown in FIGS. 50 to 52, the storage crate 2200 includes a connecting frame 2211 and a covering fabric (not shown) sleeved on the connecting frame 2211. The covering fabric sleeved outside the connecting frame 2211 forms a storage space for accommodating articles. The connecting frame 2211 is a roughly square frame is arranged on the front foot support rods 2120. In this way, the storage crate 2200 will not interfere with the second sitting assembly 2160 arranged between the two rear foot support rods 2130, thus achieving the effect of coexistence of the storage crate 2200 and the second sitting assembly 2160 located below.

In this embodiment, as shown in FIGS. 50 to 52, the storage crate 2200 is connected to the two front foot support rods 2120 by the first engagement seats 2400 and the second engagement seats 2500. Of course, in other embodiments, the storage crate 2200 can also be connected to the two front foot support rods 2120 in other ways. There are two first engagement seats 2400 and two second engagement seats 2500, which are respectively used for connecting the left and right sides of the connecting frame 2211 to the two front foot support rods 2120. The following description will take the first engagement seat 2400 and the second engagement seat 2500 on one side as examples:

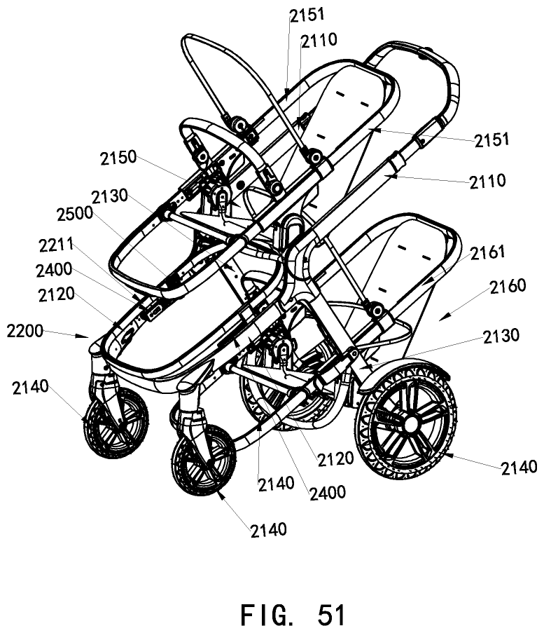

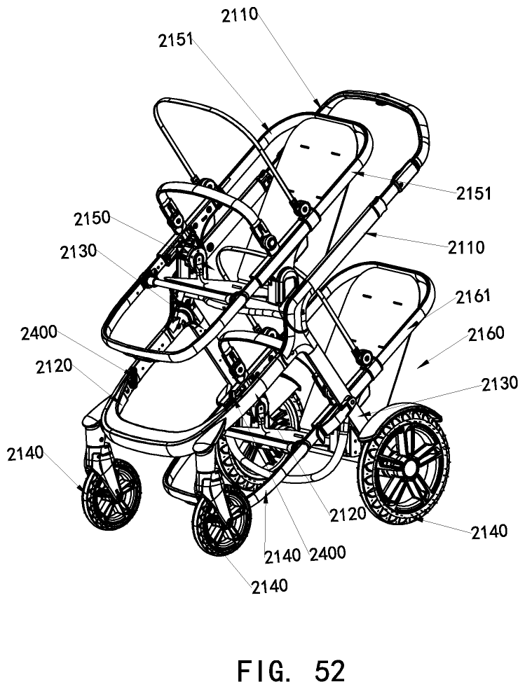

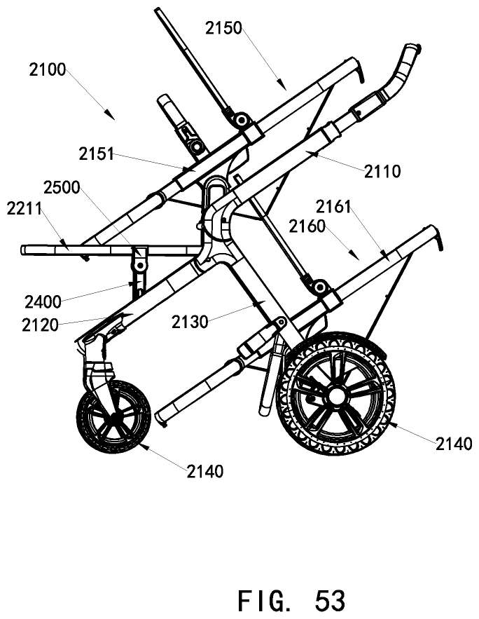

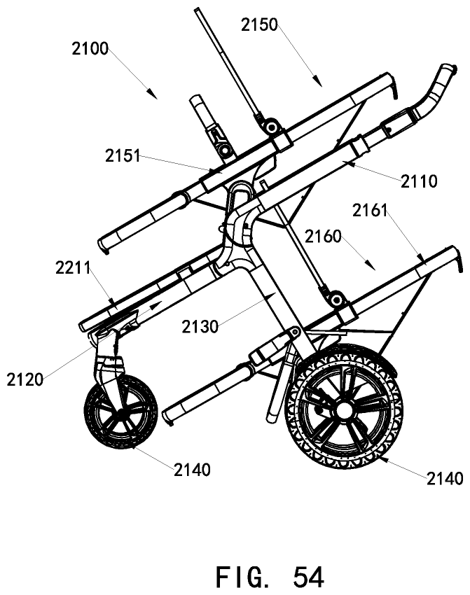

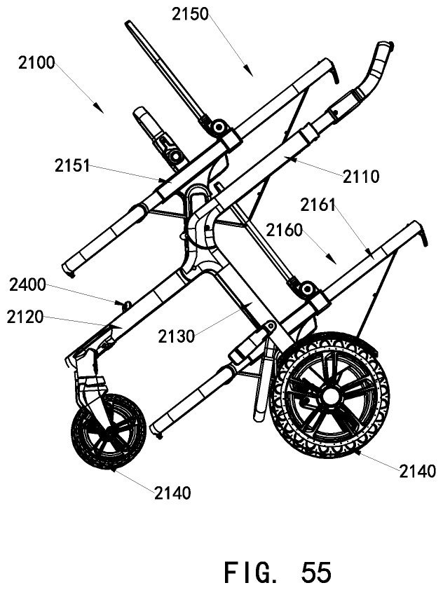

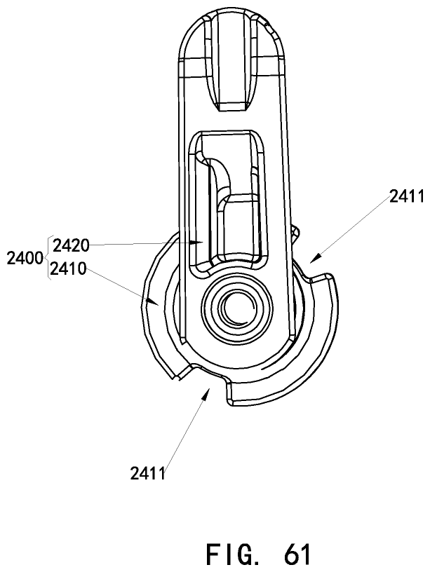

As shown in FIGS. 61 to 63, the first engagement seat 2400 includes a turntable 2410 and a connecting member 2420 connected to each other. In this embodiment, the turntable 2410 and the connecting member 2420 are integrally formed. In other embodiments, the turntable 2410 and the connecting member 2420 may also be two independent components connected to each other. The turntable 2410 is rotatably connected to the front foot support rod 2120, and the turntable 2410 is provided with two relatively arranged cooperative slots 2411. The second engagement seat 2500 has a roughly long strip-like structure. As shown in FIG. 50, one end of the second engagement seat 2500 is rotatably connected to a roughly middle position of one side of the connecting frame 2211, and the other end of the second engagement seat 2500 is rotatably connected to the end of the connecting member 2420 away from the turntable 2410. In this way, the first engagement seat 2400 and the second engagement seat 2500 form a structure similar to a rotating joint. When the storage crate 2200 is not needed, the connecting frame 2211 can be rotated and folded into a state roughly overlapping with the front foot support rod 2120, thus saving space while not affecting taking out the child from the second sitting assembly 2160, as shown in FIG. 51. In addition, the other end of the second engagement seat 2500 can be detachably connected to the end of the connecting member 2420 away from the turntable 2410, such that when the storage crate 2200 is not needed for a long time, the second engagement seat 2500 and the first engagement seat 2400 can be separated, so as to detach the storage crate 2200 from the stroller frame 2100, as shown in FIG. 52.

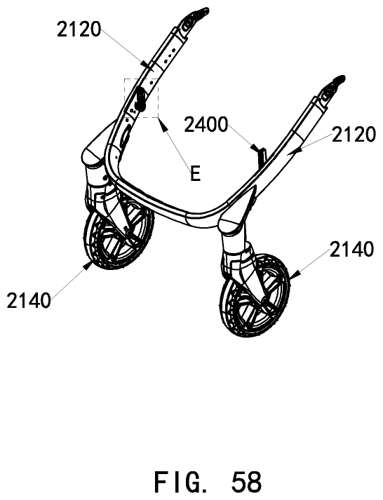

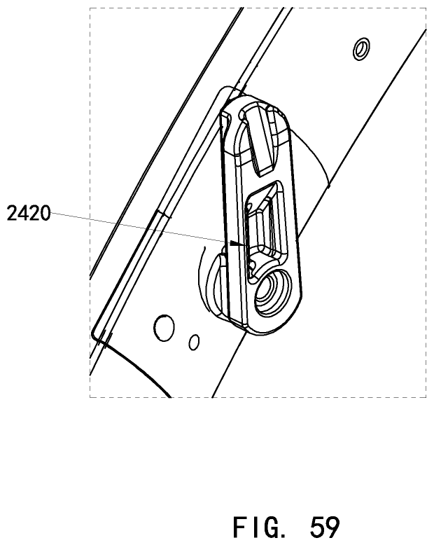

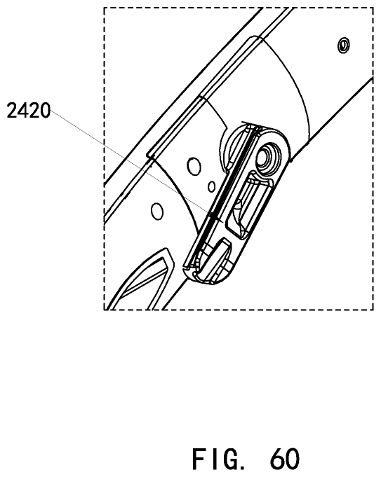

Of course, in other embodiments, as shown in FIGS. 58 to 60, the first engagement seat 2400 may only include the connecting member 2420, which is not limited.

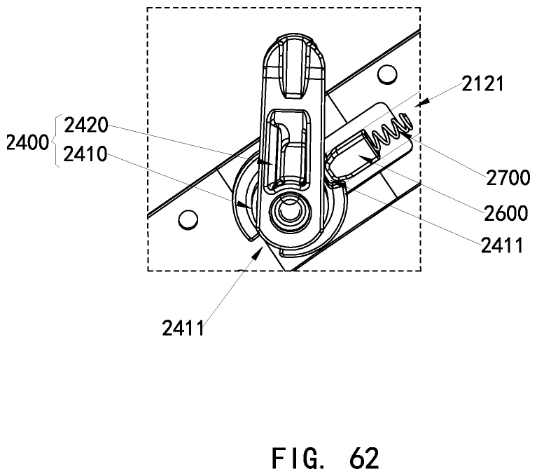

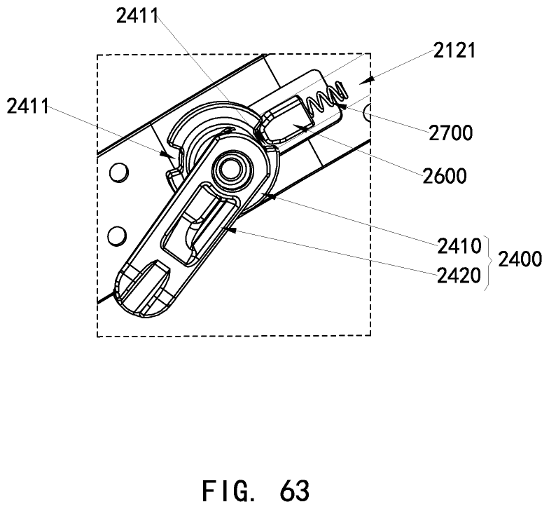

Further, as shown in FIGS. 62 and 63, the front foot support rod 2120 is provided with an installation slot 2121, and one of the cooperative pins 2600 is movably arranged in the installation slot 2121. One end of one of the second reset members 2700 abuts against a slot bottom of the installation slot 2121, and the other end abuts against the cooperative pin 2600. The second reset member 2700 always biases the cooperative pin 2600 to move toward a direction close to the cooperative slots 2411, and the cooperative pin 2600 can be inserted into any cooperative slot 2411 to locate the first engagement seat 2400 at a certain position. In this embodiment, the second reset member 2700 is a spring. Of course, in other embodiments, the second reset member 2700 can also be other elastic structures. For example, the two cooperative slots 2411 may be a first cooperative slot 2411 and a second cooperative slot 2411. When the first engagement seat 2400 rotates till the cooperative pin 2600 is inserted into the first cooperative slot 2411, as shown in FIG. 62, the first engagement seat 2400 is in a state where the connecting member 2420 is roughly vertical, and the first engagement seat 2400 and the second engagement seat 2500 cooperate with each other to make the storage crate 2200 in a completely opened state. When the second engagement seat 2500 rotates till the cooperative pin 2600 is inserted into the second cooperative slot 2411, as shown in FIG. 63, the first engagement seat 2400 is in a state where the connecting member 2420 is inclined downward, and the first engagement seat 2400 and the second engagement seat 2500 cooperate with each other to make the storage crate 2200 in a completely folded state. Of course, number and arrangement of the cooperative slots 2411 can also be adjusted according to actual requirements. For example, one more cooperative slot 2411 can be provided, such that the storage crate 2200 has a semi-folded state between the completely opened state and the completely folded state, etc., which is not limited. Of course, the way to realize position locking of the first engagement seats 2400 is not limited to the way in which the cooperative slots 2411 and the cooperative pins 2600 cooperate with each other as described in this embodiment, rather, there can be many variations as long as position locking of first engagement seat 2400 can be realized.

The stroller has at least the following technical effects:

In such stroller, the storage crate 2200 is arranged on the front foot support rods 2120 of the stroller frame 2100, which is convenient for the spatial structure design of the stroller. Particularly for the stroller with upper and lower double seats, the storage crate 2200 is arranged on the front foot support rods 2120, which can avoid interference of the lower seat of the stroller to the storage crate 2200, thus realizing the effect of coexistence of the storage crate 2200 and the lower seat.

The technical features of the above embodiments can be combined arbitrarily. In order to make the description concise, not all possible combinations of the technical features in the embodiments are described. However, as long as there is no contradiction between the combinations of these technical features, they should be considered as falling within the scope recorded in this specification.

Since the application can be embodied in various forms without departing from the spirit and essence of the application, it should be understood, the above embodiments are not limited to any of the foregoing details, but should be interpreted in the broadest sense within the scope defined by the claims. Therefore, all changes that fall within the scope of the claims or their equivalents should be covered by the claims.

### LIST OF REFERENCE SIGNS

1110 Housing
1111 Indication Window
1112 Insertion Slot
1113 Pin Hole
1114 Wheel Axle Hole
1120 Wheel
1121 Parking Hole
1122 Wheel Axle
1130 Pin
1131 Pin Inserting Portion
1132 Pin Abutting Portion
1133 Pin Elastic Member Accommodating Portion
1134 First Indicating Portion
1135 Second Indicating Portion
1140 Driving Member
1141 First Axis
1142 Driving Member Shaft Hole
1143 Engagement Tooth Groove
1143a Engagement Limit Portions
1143b Avoidance Limit Portions
1143c Engagement Tooth Elastic member Abutting Portions
1144 Engagement Tooth Shafts
1145 Parking Portion
1146 non-parking Portion
1147 Driving Slope
1150 Engagement Tooth
1151 Forward Face
1152 backward Face
1153 Engagement Tooth Shaft Hole
1154 Engagement Tooth Elastic Member Accommodation Portion
1155 Second Axis
1160 Operating Member
1161 Operating Member body
1162 Pedal
1163 Pushing Portion
1164 Insertion Post
1170 Linkage Slider
1171 Cable First End Connecting Portion
1172 Slider Slope
1180 Linkage Seat
1181 Linkage Seat Abutment Portion
1182 Cylindrical Portion
1183 Slope Portion
1191 Cable
1191a Hammer Head
1192 Operating Elastic Member
1193 Engagement tooth Elastic Member
1194 Pin Elastic Member
1195 Linkage Seat Elastic Member
1210 The Other Housing
1220 The Other Wheel
1230 The Other Pin
1234 The Other First Indicating Portion
1235 The Other Second Indicating Portion
1240 The Other Driving Member
1241 Cable Second End Connecting Portion
1245 The Other Parking Portion
1246 The Other Non-Parking Portion
1247 The Other Driving Slope
1294 The Other Pin Elastic Member
1300 Stroller Frame
2100 Stroller Frame
2110 Handrail Support Rod
2111 Slide Rail
2120 Front Foot Support Rod
2121 Installation Slot
2130 Rear Foot Support Rod
2140 Wheel Assembly
2150 First Sitting Assembly
2151 First Backrest Support Rod
2160 Second Sitting Assembly
2161 Second Backrest Support Rod
2200 Storage Crate
2210 Storage Basket
2211 Connecting Frame
2211a First Connecting Tube
2211b Second Connecting Tube
2220 Handlebar
2221 Crossbar
2222 Strut
2300 Locking Mechanism
2310 Fixed Seat
2311 Chute
2312 Engagement Hole
2313 Cooperative Bulge
2320 Actuating Member
2321 Connecting Portion
2322 Driving Body
2322a Accommodation Slot
2322b Positioning Concave
2322c Pushing Rib
2322d First Pivot Hole
2330 Connecting Seat
2331 Cooperative Groove
2332 Accommodation Hole
2333 Connecting Arm
2334 Second Pivot Hole
2340 Connecting Pin
2350 Connecting Cover
2351 Third Pivot Hole
2360 Pushing Block
2370 Engagement Block
2380 First Reset Member
2390 Positioning Member
2391 Connecting Hole
2392 Elastic Arm
2392a Positioning Convex
2393 Fourth Pivot Hole
2400 First Engagement Seat
2410 Turntable
2411 cooperative Slot
2420 Connecting Member
2500 Second Engagement Seat
2600 Cooperative Pin
2700 Second Reset Member

1. An intermittent movement device, comprising:
a housing;
a driving member, capable of rotating around a first axis;
a plurality of engagement teeth, circumferentially distributed on the driving member based on the first axis; and
an operating member, capable of performing reciprocating movement between an initial position and an acting position with respect to the housing around the first axis;
wherein, when the operating member moves from the acting position to the initial position, the operating member passes over one of the engagement teeth to return from the acting position to the initial position, and the driving member does not rotate with the operating member.

2. The intermittent movement device according to claim 1, wherein:
the plurality of engagement teeth are capable of rotating between a respective engagement position and an avoidance position with respect to the driving member;
when the operating member moves from the initial position to the acting position, the operating member pushes one of the engagement teeth into the engagement position, and brings the driving member to rotate along a rotating direction via one of the engagement teeth; and
when the operating member moves from the acting position to the initial position, the operating member passes over a next one of the engagement teeth behind the one of the engagement teeth in the rotating direction to return from the acting position to the initial position, and the driving member does not rotate with the operating member.

3. The intermittent movement device according to claim 2, wherein:
each of the engagement teeth is capable of rotating between the engagement position and the avoidance position with respect to the driving member around a respective second axis, and the second axis is parallel to the first axis.

4. The intermittent movement device according to claim 2, wherein:
each of the engagement teeth includes a forward face and a backward face, and the forward face and the backward face form an included angle with each other;
the operating member includes a pushing portion to exert a pushing action on one of the engagement teeth;
when the operating member moves from the initial position to the acting position, the pushing portion of the operating member pushes against the forward face of one of the engagement teeth, such that one of the engagement teeth is in the engagement position; and
when the operating member moves from the acting position to the initial position, the pushing portion-passes over the next one of the engagement teeth and makes the next one of engagement teeth in its avoidance position by pushing against the backward face of the next one of engagement teeth.

5. The intermittent movement device according to claim 2, wherein, the intermittent movement device further comprises:
a plurality of engagement tooth elastic members, respectively arranged between the plurality of engagement teeth and the driving member to bias the engagement teeth to the engagement position;
the engagement teeth protrude farther radially with respect to the first axis in the engagement position than in the avoidance position.

6. The intermittent movement device according to claim 5, wherein:
the engagement tooth elastic members are compression springs, and each of the engagement teeth includes an engagement tooth elastic member accommodation portion to at least partially accommodate one end of each of the engagement tooth elastic members.

7. The intermittent movement device according to claim 6, wherein:
the driving member includes:
a plurality of engagement tooth grooves, concavely formed from one side surface of the driving member, and distributed circumferentially based on the first axis, so as to respectively accommodate the plurality of engagement teeth, wherein each of the engagement tooth grooves includes:
an engagement limit portion, for resisting a corresponding one of the engagement teeth from further rotating beyond the engagement position with respect to the driving member when the engagement tooth is in its engagement position;
an avoidance limit portion, for resisting a corresponding one of the engagement teeth from further rotating beyond the avoidance position with respect to the driving member when the engagement tooth is in its avoidance position; and
an engagement tooth elastic member abutting portion, arranged adjacent to the avoidance limit portion for being abutted against by the other end of the engagement tooth elastic member.

8. The intermittent movement device according to claim 7, wherein:
the engagement limit portions, the avoidance limit portions, and the engagement tooth elastic member abutting portions are all axially extending walls of the engagement tooth grooves, and the engagement limit portions are radially opposite to both the avoidance limit portions and the engagement tooth elastic member abutting portions, wherein the engagement limit portions are radial outer side walls of the engagement tooth grooves, the avoidance limit portions and the engagement tooth elastic member abutting portions are respectively radial inner side walls of the engagement tooth grooves.

9. The intermittent movement device according to claim 1, wherein:
a stroke of each reciprocating movement of the operating member is equal to or greater than a spacing between two adjacent engagement teeth.

10. The intermittent movement device according to claim 1, wherein:
the operating member further includes an operating member body, and the operating member body is coaxially arranged with the driving member along the first axis;
the plurality of engagement teeth are arranged on a side of the driving member facing the operating member body; and
a pushing portion is disposed on a side of the operating member body facing the driving member, and the pushing portion is arranged to protrude axially and push against one of the engagement teeth when the operating member moves from the initial position to the acting position.

11. The intermittent movement device according to claim 10, wherein:
the housing includes a disk-shaped surface opposite to the operating member body, and a circumferentially extending insertion slot is formed in the disk-shaped surface;
the operating member further includes an insertion post, and the insertion post extends axially toward an interior of the housing;
the insertion post is inserted into the insertion slot, slides along the insertion slot when the operating member performs reciprocating movement with respect to the driving member, and the insertion slot limits a stroke of the movement of the operating member between the acting position and the initial position; and
the intermittent movement device further comprises an operating elastic member, the operating elastic member is disposed in the insertion slot and abuts between an end wall of the insertion slots and the insertion post, biasing the operating member to the initial position.

12. A wheel locking structure, comprising:
the intermittent movement device according to claim 1;
a wheel, rotatably connected to the housing around the first axis, wherein the wheel is provided with a parking hole on a side facing the housing, and the operating member and the wheel are located on opposite sides of the driving member;
a pin, disposed in the housing and located between the driving member and the wheel, and capable of moving axially between a parking position and a non-parking position, wherein, in the parking position, the pin is inserted into the parking hole to prevent the wheel from rotating, and in the non-parking position, the pin leaves the parking hole to allow the wheel to rotate;
wherein the driving member of the intermittent movement device is rotatably connected in the housing and abutting against one end of the pin, the driving member is provided with parking portions protruding toward the wheel and non-parking portions recessed away from the wheel on a side abutting against the pin, and as the driving member rotates, one of the parking portions or one of the non-parking portions abuts against the pin, such that the pin moves to the parking position or the non-parking position.

13. The wheel locking structure according to claim 12, wherein:
the pin is provided with a first indicating portion and a second indicating portion which are axially arranged and have different visual effects;
a circumferential wall of the housing is provided with an indication window, wherein, when the pin is in the non-parking position, the first indicating portion is exposed to outside corresponding to a position of the indication window, and when the pin is in the parking position, the second indicating portion is exposed to outside corresponding to the position of the indication window.

14. The wheel locking structure according to claim 12, wherein:
a pin elastic member is disposed between the pin and the housing, and the pin elastic member biases the pin to the non-parking position.

15. The wheel locking structure according to claim 12, wherein:
the parking portions and the non-parking portions are alternately distributed around the first axis.

16. The wheel locking structure according to claim 10, wherein:
the wheel locking structure further comprises:
the other wheel, arranged in pair with the wheel and rotatably connected to the other housing around the first axis, and wherein the other wheel is provided with the other parking hole on a side facing the other housing;
the other pin, arranged in the other housing, capable of moving axially between its parking position and non-parking position, wherein, in the parking position of the other pin, the other pin is inserted into the other parking hole to prevent the other wheel from rotating, and in the non-parking position of the other pin, the other pin leaves the other parking hole to allow the other wheel to rotate;
the other driving member, rotatably connected in the other housing and connected against one end of the other pin, wherein the other driving member is provided with the other parking portion protruding toward the other wheel and the other non-parking portion recessed away from the other wheel on a side abutting against the other pin, and as the other driving member rotates, the other parking portion or the other non-parking portion abuts against the other pin, such that the other pin moves to the other parking position or the other non-parking position;
a cable, having one end connected to a cable second end connecting portion at a periphery of the other driving member, and the other end connected to the driving member through a linkage mechanism, wherein, when one of the parking portions of the driving member abuts against the pin to enter its parking position, the driving member brings the other driving member to move by the linkage mechanism and the cable, such that the other driving member rotates to the other parking portion abutting against the other pin to enter it parking position.

17. The wheel locking structure according to claim 16, wherein:
the linkage mechanism includes:
a linkage slider, disposed in the housing and capable of sliding with respect to the wheel in a direction perpendicular to the first axis, and wherein the other end of the cable is connected to a cable first end connecting portion of the linkage slider;
a linkage seat, disposed in the housing and capable of sliding with respect to the wheel in a direction parallel to the first axis, wherein the linkage seat and the linkage slider are engaged in an inclined plane; and
the linkage mechanism is configured such that when one of the parking portions abuts against the pin, another one of the parking portions abuts against the linkage seat, such that the linkage seat slides in a direction parallel to the first axis, and the linkage seat brings the linkage slider to slide vertically to the first axis through inclined plane engagement, and the linkage slider brings the other driving member to rotate through the cable.

18. A stroller, comprising:
a stroller frame;
a stroller seat, erected on the stroller frame;
a front wheel and a rear wheel, disposed below the stroller frame; and
the wheel locking structure according to claim 12, wherein the wheel is the front wheel or the rear wheel.

19-43. (canceled)

44. The wheel locking structure according to claim 1, wherein:
each of the engagement teeth is capable of linearly moving between an engagement position and an avoidance position along a direction perpendicular to the first axis;
when the operating member moves from the initial position to the acting position, the operating member pushes one of the engagement teeth into the engagement position, and brings the driving member to rotate along a rotating direction via one of the engagement teeth; and
when the operating member moves from the acting position to the initial position, the operating member passes over a next one of the engagement teeth behind the one of the engagement teeth in the rotating direction to return from the acting position to the initial position, and the driving member does not rotate with the operating member.
